(19) United States
(12) Patent Application Publication
(10) Pub. No.: US 2015/0146649 A1
(43) Pub. Date: May 28, 2015

(54) COMMUNICATION APPARATUS, COMMUNICATION METHOD, AND RECORDING MEDIUM

(71) Applicant: HITACHI, LTD., Tokyo (JP)

(72) Inventors: Taisuke UETA, Tokyo (JP); Hideki ENDO, Tokyo (JP); Masayuki TAKASE, Tokyo (JP); Yusuke YAJIMA, Tokyo (JP); Masanobu KOBAYASHI, Tokyo (JP)

(21) Appl. No.: 14/551,815

(22) Filed: Nov. 24, 2014

(30) Foreign Application Priority Data
Nov. 27, 2013 (JP) 2013-244853

(51) Int. Cl. H04L 12/741; H04W 72/04

(52) U.S. Cl. CPC H04L 45/745; H04W 72/0453
USPC 370/329

(57) ABSTRACT

A communication apparatus includes: a table set group comprising a plurality of table sets each containing a plurality of 1RD/1WR-configuration tables; a latest access holding table for specifying, for each flow, one of the table sets as the latest access destination of the each flow; and an updating unit for selecting, when a reference made to the latest access destination holding table with respect to a plurality of simultaneously received write requests shows that access destinations of flows indicated by the respective write requests are the same table set, a different table set for each of the flows indicated by the respective write requests, executing write processing in each table of the selected table set, and updating the latest access holding table so that the access destinations after the write processing are registered as access destinations of the flows indicated by the respective write requests.

### CLAIM OF PRIORITY

The present application claims priority from Japanese patent application JP 2013-244853 filed on Nov. 27, 2013, the content of which is hereby incorporated by reference into this application.

### BACKGROUND OF THE INVENTION

This invention relates to a communication apparatus for communicating packets, a communication method, and a recording medium.

Network systems have been experiencing heavy traffic in recent years due to the digitization of television program contents, the popularization of smartphones, or other reasons. This has caused a rapid increase in the communication bandwidth of carriers' backbones, and the demand for a packet processing circuit that exceeds a processing speed of 100 gigabit per second (Gbps) is rising.

Field-programmable gate arrays (FPGAs), which have all of speed, flexibility, and short development time, are used in packet processing circuits of a wide variety of communication apparatus. In FPGA development that has been made up to now, the enhancement of processing speed for the purpose of dealing with the increase in communication bandwidth has been accomplished by elevating the operating frequency inside the FPGA and raising the number of parallelly deployed bits. However, improvement in operating frequency is slowing down and, to accomplish a packet processing speed that exceeds 100 Gbps with the same FPGA, the number of parallelly deployed bits needs to be raised to 64 bytes (512 bits), which is the minimum size in the Ethernet (trademark), or higher. In the case of the minimum size, a plurality of packets arrive in one clock cycle (clk).

In the case where a packet management function such as a band control function or a statistics counting function is installed in an FPGA, the FPGA stores information of packets for each of flows which are logically multiplexed to be accommodated by the communication apparatus so that packet information of one flow is stored in a single information storage medium (hereinafter referred to as table), and the value of a flow-by-flow table that is associated with an arrived packet is updated every time a packet arrives.

The FPGA implements a band control function by managing a consumed bandwidth for each flow in a table. Specifically, each time a packet arrives, the FPGA reads (hereinafter abbreviated as RD) a set bandwidth and a consumed bandwidth out of the table of the packet's flow and, after a comparison to the set bandwidth and a computation of the consumed bandwidth, writes (hereinafter abbreviated as WR) the result of the consumed bandwidth update to the table. Processing of updating a table based on information about a packet, such as the processing from an RD through a WR described above, is hereinafter referred to as table updating processing.

To carry out band control with an FPGA at a packet processing speed that exceeds 100 Gbps, for example, 400 Gbps, pieces of packet information of two or more packets arrive in one clk, and at least two RDs and at least two WRs need to be processed simultaneously in one clk.

The background art in the technical field of this invention includes JP 2000-216883 A. JP 2000-216883 A includes a description that reads “one multi-port RAM switch unit includes a plurality of write circuits and a plurality of read circuits, each of which operates at a timing rate that is a prescribed fraction of the input/output clock rate of the input/output ports of the multi-port RAM based cross-connect switching fabric” (see Abstract). In short, JP 2000-216883 A proposes a technology that uses a multi-port RAM capable of executing a plurality of RDs and a plurality of WRs in a table within one clk of packet processing.

In the case of using an FPGA for high-speed packet processing of recent years, however, only one RD and one WR can be processed in one clk due to the FPGA's high operating frequency. Specifically, because the FPGA has, instead of a multi-port RAM, a dual-port RAM which has two access ports and which allows the FPGA to process one RD and one WR (or two RDs alone or two WRs alone) in one clk, the FPGA cannot execute two or more RDs and two or more WRs in a table simultaneously in one clk, unlike the technology described in JP 2000-216883 A. The resultant problem is that table updating processing of a band control function or a statistics counting function cannot be accomplished when two or more packets arrive in one clk.

### SUMMARY OF THE INVENTION

This invention has been made in view of the problem described above, and therefore it is an object of this invention to speed up table updating processing to a level that can deal with the arrival of a plurality of packets in one clk.

An aspect of the invention disclosed in this application is a communication apparatus to be coupled to a network, comprising: a table set group comprising a plurality of table sets each containing a plurality of tables capable of processing one read request and one write request from the network at the same timing, and holding flow-by-flow information in a synchronized manner; a latest access holding table for specifying, for each flow, one of the plurality of table sets that is a latest access destination of the each flow; and an updating unit for selecting, when a reference made to the latest access holding table with respect to a plurality of write requests received simultaneously from the network shows that access destinations of flows indicated by the respective write requests are the same table set, as an access destination, a different table set out of the plurality of table sets for each of the flows indicated by the respective write requests, executing write processing in each table in one of the plurality of table sets that is the selected access destination, and updating the latest access holding table so that the access destinations after the write processing are registered as access destinations of the flows indicated by the respective write requests.

According to one embodiment of this invention, the table updating processing is improved in speed when the plurality of read requests and write requests arrive in one clk.

### BRIEF DESCRIPTION OF THE DRAWINGS

FIG. 1A is an explanatory diagram outlining the packet arrival interval and table updating processing timing in the case where one packet arrives in two clks.

FIG. 1B is an explanatory diagram outlining the packet arrival interval and table updating processing timing in the case where two packets arrive in one clk.

FIG. 2A is an explanatory diagram illustrating an RD access processing example for multi-RD/multi-WR in the embodiments of this invention.

FIG. 2B is an explanatory diagram illustrating a WR access processing example for multi-RD/multi-WR in the embodiments of this invention.

FIG. 3 is a block diagram illustrating the physical configuration of and a logical circuit of a communication apparatus according to the first embodiment.

FIG. 4 is a block diagram illustrating the logical configuration of the input packet control unit according to the first embodiment.

FIG. 5 is a block diagram illustrating the logical configuration of the input table updating unit according to the first embodiment.

FIG. 6 is an explanatory diagram illustrating the latest access holding tables of the first embodiment.

FIG. 7 is an explanatory diagram illustrating the computation tables of the first embodiment.

FIG. 8 is an explanatory diagram illustrating the access flow management list of the first embodiment.

FIG. 9 is a flow chart illustrating the RD access table searching processing S950, which is executed by the access table searching modules of the first embodiment.

FIG. 10 is a flow chart illustrating the WR access table searching processing S1050, which is executed by the access table searching modules of the first embodiment.

FIG. 11 is a flow chart illustrating the RD access table selecting processing S1150, which is executed by the access table selecting module of the first embodiment.

FIG. 12A is a flow chart (first half) illustrating a detailed processing procedure example of the WR access table selecting processing S1250, which is executed by the access table selecting module of the first embodiment.

FIG. 12B is a flow chart (second half) illustrating a detailed processing procedure example of the WR access table selecting processing S1250, which is executed by the access table selecting module of the first embodiment.

FIG. 13 is a flow chart illustrating the access flow management processing S1350, which is executed by the input table updating unit of the first embodiment.

FIG. 14 is an explanatory diagram illustrating computation results that are produced when table updating processing of the first embodiment is executed.

FIG. 15 is an explanatory diagram outlining the packet arrival interval and table updating processing timing in the second embodiment.

FIG. 16 is a block diagram illustrating the logical configuration of an input packet control unit according to the second embodiment.

FIG. 17 is a block diagram illustrating the logical configuration of the input table updating unit of the second embodiment which is illustrated in FIG. 16.

FIG. 18 is an explanatory diagram illustrating the latest access holding table sets of the second embodiment.

FIG. 19 is an explanatory diagram illustrating the access flow management list of the second embodiment.

FIG. 20 is a flow chart illustrating the RD access table selecting processing S2050, which is executed by the access table selecting module of the second embodiment.

FIG. 21A is a flow chart (first half) illustrating a detailed processing procedure example of the WR access table selecting processing S2150, which is executed by the access table selecting module 1703 of the second embodiment.

FIG. 21B is a flow chart (second half) illustrating a detailed processing procedure example of the WR access table selecting processing S2150, which is executed by the access table selecting module of the second embodiment.

FIG. 22 is an explanatory diagram illustrating an example of latest access destination information changing processing in the WR access table selecting processing S2150, which is executed by the access table selecting module, of the second embodiment.

FIG. 23 is an explanatory diagram outlining the packet arrival interval and table updating processing timing in the third embodiment.

FIG. 24 is a block diagram illustrating the logical configuration of the input table updating unit of the third embodiment.

FIG. 25 is an explanatory diagram illustrating the statistics tables of the third embodiment.

FIG. 26 is a flow chart illustrating the statistics notifying processing S2650, which is executed by the statistics adding-up module of the third embodiment.

FIG. 27 is an explanatory diagram illustrating the trends of FPGA operating frequency and line interface speed.

### DETAILED DESCRIPTION OF THE PREFERRED EMBODIMENTS

Now, embodiments of this invention are described with reference to the accompanying drawings. The following embodiments are examples of this invention and are not to limit this invention. The trends of FPGA operating frequency and line interface speed in the embodiments of this invention are described.

<FPGA Operating Frequency Trend and Line IF Speed Trend>

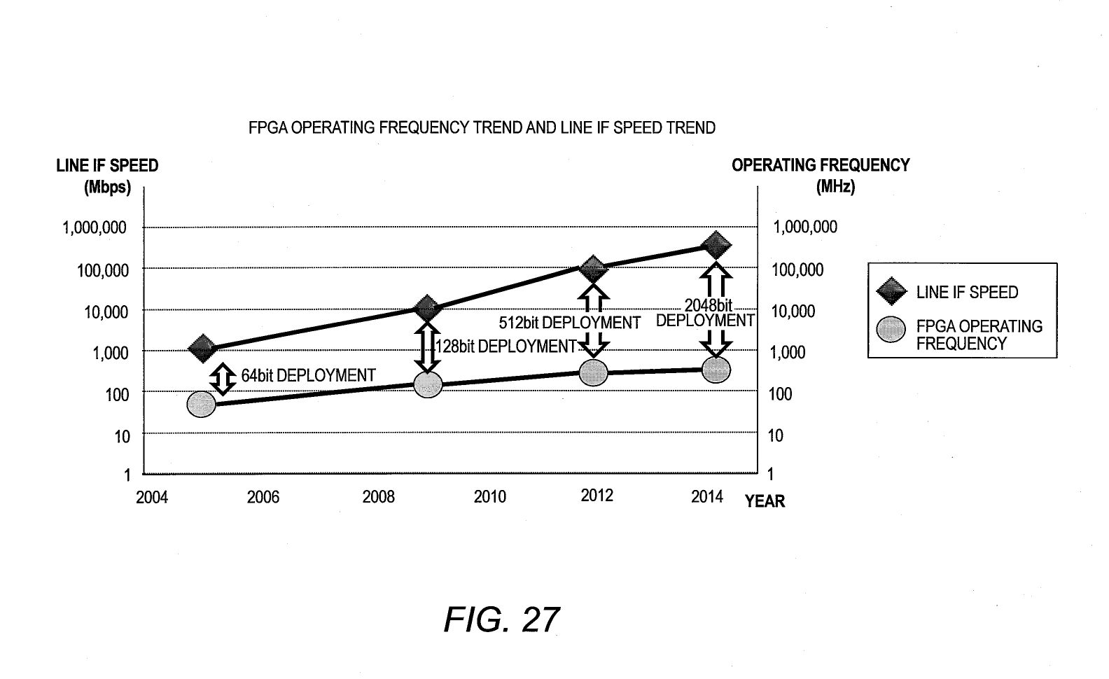

FIG. 27 is an explanatory diagram illustrating the trends of FPGA operating frequency and line interface speed. An FPGA accomplishes packet processing at a line interface speed by raising the operating frequency and increasing the number of parallelly deployed bits. Packet processing is binary digit processing in which a packet is processed in units of eight bits, and it is therefore common for the number of parallelly deployed bits to be in units of powers of 2. While FPGA operating frequency is rising, the rate of the rise is slowing down. The line interface speed, on the other hand, is increasing rapidly. The number of parallelly deployed bits inside an FPGA is therefore on a growing trend, and needs to be 2,048 in order to achieve a line interface speed of 400 Gbps, for example.

Accordingly, to accomplish a packet processing speed of 400 Gbps, for example, with this FPGA, the number of parallelly deployed bits needs to be 64 bytes (512 bits), which is the minimum size in the Ethernet, or higher. In the case of the minimum size, a plurality of packets arrive in one clk.

<Packet Arrival Interval and Table Updating Processing Timing Example>

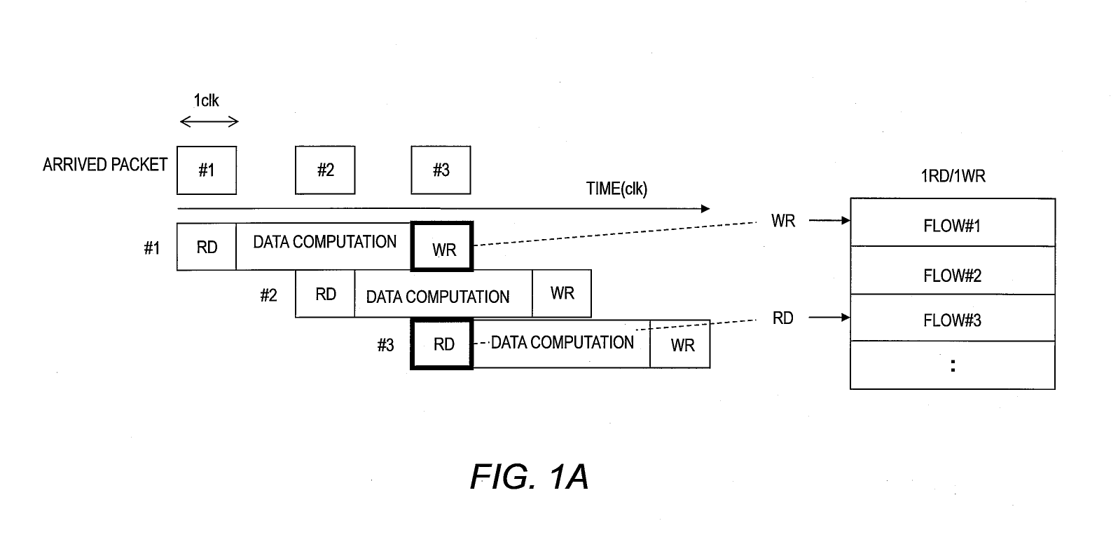

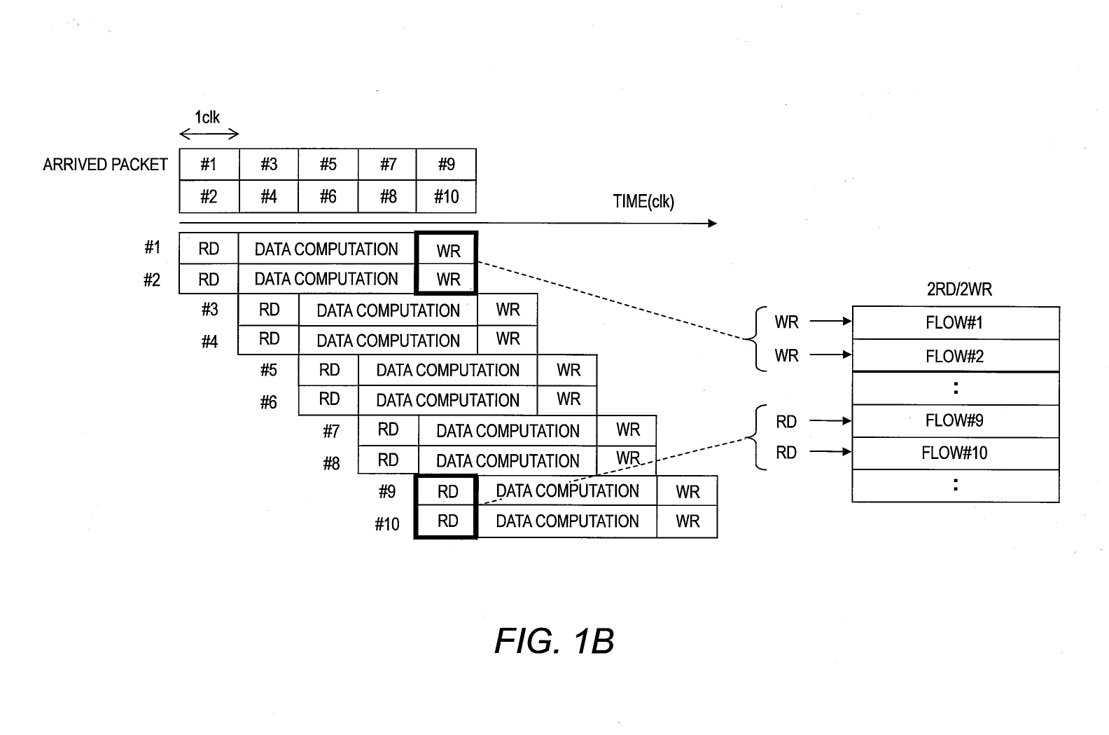

FIG. 1A is an explanatory diagram outlining the packet arrival interval and table updating processing timing in the case where one packet arrives in two clks. FIG. 1A gives an example in which the packet arrival interval in a 100-Gbps line is two clks and the length of table updating time is five clks (RD: one clk, computation: three clks, WR: one clk) (an RD and a WR may each require several clks in practice, but take one clk in FIG. 1A for the sake of simplifying the description). In this case, when packets arrive at a packet communication apparatus in succession at two-clk intervals, a WR due to the first packet arrival coincides with an RD due to the third packet arrival. This means that a table is required to process only one RD and one WR simultaneously (processing one RD and one WR simultaneously is hereinafter expressed as 1RD/1WR), and the packet communication apparatus can accordingly execute table updating processing each time a packet arrives.

FIG. 1B is an explanatory diagram outlining the packet arrival interval and table updating processing timing in the case where two packets arrive in one clk. For example, in the case where two packets arrive at the packet communication apparatus every clk and the length of table updating time is five clks as in FIG. 1A, WRs due to the first packet arrival and the second packet arrival coincide with RDs due to the ninth packet arrival and the tenth packet arrival.

A table in this case is required to process two RDs and two WRs simultaneously (processing two RDs and two WRs simultaneously is hereinafter expressed as 2RD/2WR) every clk. However, tables included in the packet communication apparatus are each a 1RD/1WR table, and cannot process two RDs and two WRs in one clk.

<Example of Processing by a Virtual Multi-Port Table>

In the embodiments of this invention, updating a table is executable even when a plurality of RD requests and a plurality of WR requests arrive at the same time as in FIG. 1B. To that end, the embodiments of this invention accomplish multi-RD/multi-WR with the use of a virtual multi-port RAM (virtual multi-port table) where a plurality of computation tables each of which is a 1RD/1WR dual-port RAM are combined.

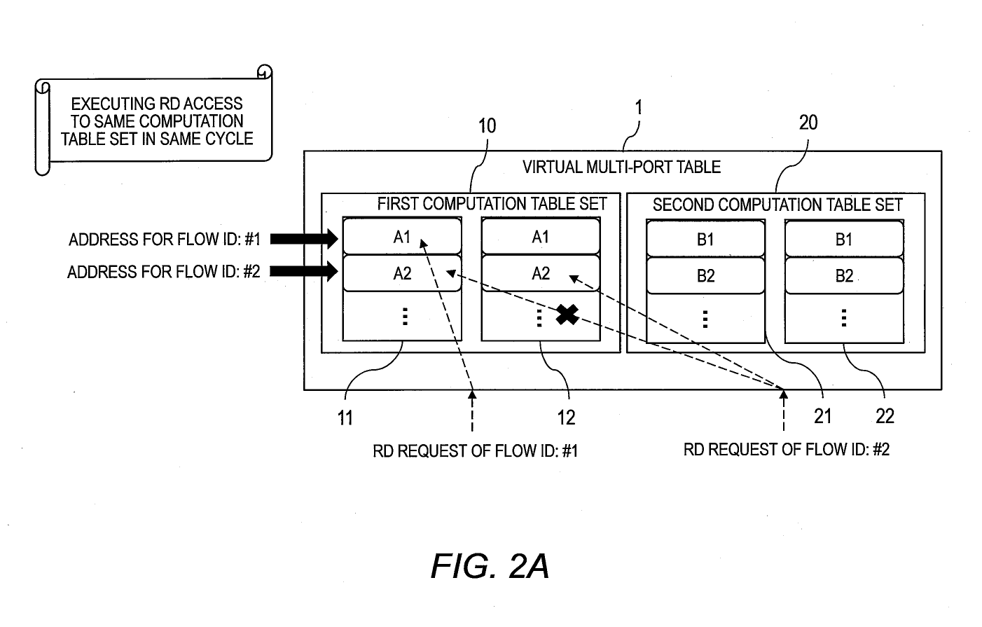

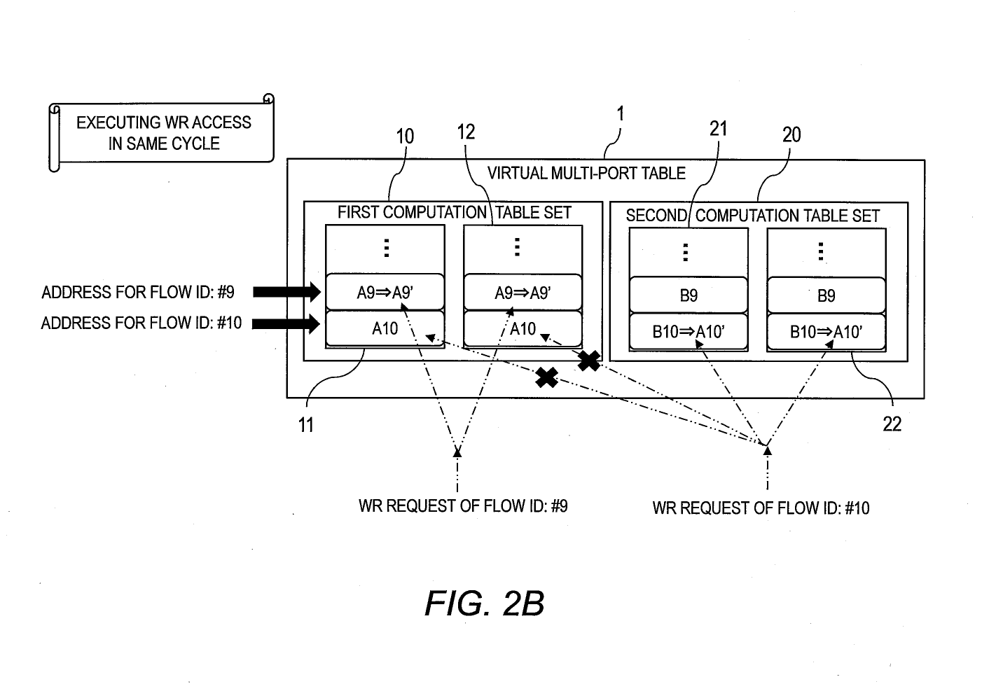

FIG. 2A and FIG. 2B are explanatory diagrams respectively illustrating an RD access processing example and a WR access processing example for multi-RD/multi-WR in the embodiments of this invention. FIG. 2A takes as an example a case of 2RD/2WR for the sake of simplifying the description. In the example of FIG. 2A, an RD request of one flow (e.g., a flow having a flow ID “#1”) and an RD request of another flow (e.g., a flow having a flow ID “#2”) are received in the same clock cycle.

In 2RD/2WR, a virtual multi-port table 1 has two sets of two computation tables. One of the sets is a first computation table set 10, and the other is a second computation table set 20. The computation table sets 10 and 20 each have two computation tables. The computation tables in the computation table set 10 which are denoted by 11 and 12 are synchronized with each other to hold the same data. The computation tables in the computation table set 20 which are denoted by 21 and 22 are synchronized with each other to hold the same data. In this example, the addresses of areas where data A1 is stored in the computation tables 11 and 12 and areas where data B1 is stored in the computation tables 21 and 22 are specified by “flow ID: #1”. Similarly, the addresses of areas where data A2 is stored and areas where data B2 is stored are specified by “flow ID: #2”.

Described here is a case in which the RD request of the flow whose flow ID is “#1” specifies the first computation table set 10 and the RD request of the flow whose flow ID is “#2” specifies the first computation table set 10 as well. The RD request where the flow ID is “#1” specifies the data A1 of the computation table 11 by “flow ID: #1”. The RD request where the flow ID is “#2”, on the other hand, specifies, by “flow ID: #2”, the data A2 of the computation table 12 which does not lead to contention with the RD request where the flow ID is “#1”, out of the data A2 of the computation table 11 and the data A2 of the computation table 12. In this manner, executing two RDs at the same time is accomplished while avoiding access contention.

A case where a WR request of a flow that has a flow ID “#9” and a WR request of a flow that has a flow ID “#10” are received in the same clock cycle is described as an example with reference to FIG. 2B. In the example of FIG. 2B, two WR requests are received at the same time as the two RD requests of FIG. 2A. The WR request where the flow ID is “#9” is a request for the WR of a computation result A9′ of a computation that uses data A9 read by an RD request of a flow that has a flow ID “#9” (not shown). Similarly, the WR request where the flow ID is “#10” is a request for the WR of a computation result A10′ of a computation that uses data A10 read by an RD request of a flow that has a flow ID “#10” (not shown).

A WR request is processed by executing a WR in both of the two computation tables in each computation table set in order to synchronize the two computation tables with each other. Processing the WR request where the flow ID is “#9” involves overwriting the computation result A9′ in an area of the computation table 11 out of which the data A9 has been read, and also overwriting the computation result A9′ in an area of the computation table 12 where the data A9 has been stored. This ensures that any one of the computation tables 11 and 12 can be used in an RD that is executed by a subsequently received RD request where the flow ID is “#9”.

Processing the WR request where the flow ID is “#10”, on the other hand, involves accessing, instead of the first computation table set 10, the second computation table set 20, which does not lead to contention with the WR request where the flow ID is “#9”, and overwriting the computation result A10′ in areas of the computation tables 21 and 22 of the second computation table set 20 where the data B10 has been stored. This ensures that any one of the computation tables 21 and 22 can be used in an RD that is executed by a subsequently received RD request where the flow ID is “#10”. Not accessing the first computation table set 10 also ensures that two WRs in the same cycle are accomplished by avoiding access contention with the WR request where the flow ID is “#9”. With the access destination of requests where the flow ID is “#10” changed from the first computation table set 10 to the second computation table set 20, read and write are controlled so that the destination of access made to fulfill RD requests and WR requests where the flow ID is “#10” is the second computation table set 20.

In this manner, a plurality of RDs and a plurality of WRs can be executed in the virtual multi-port table 1 even when a plurality of RD requests and a plurality of WR requests are received in the same clock cycle.

### First Embodiment

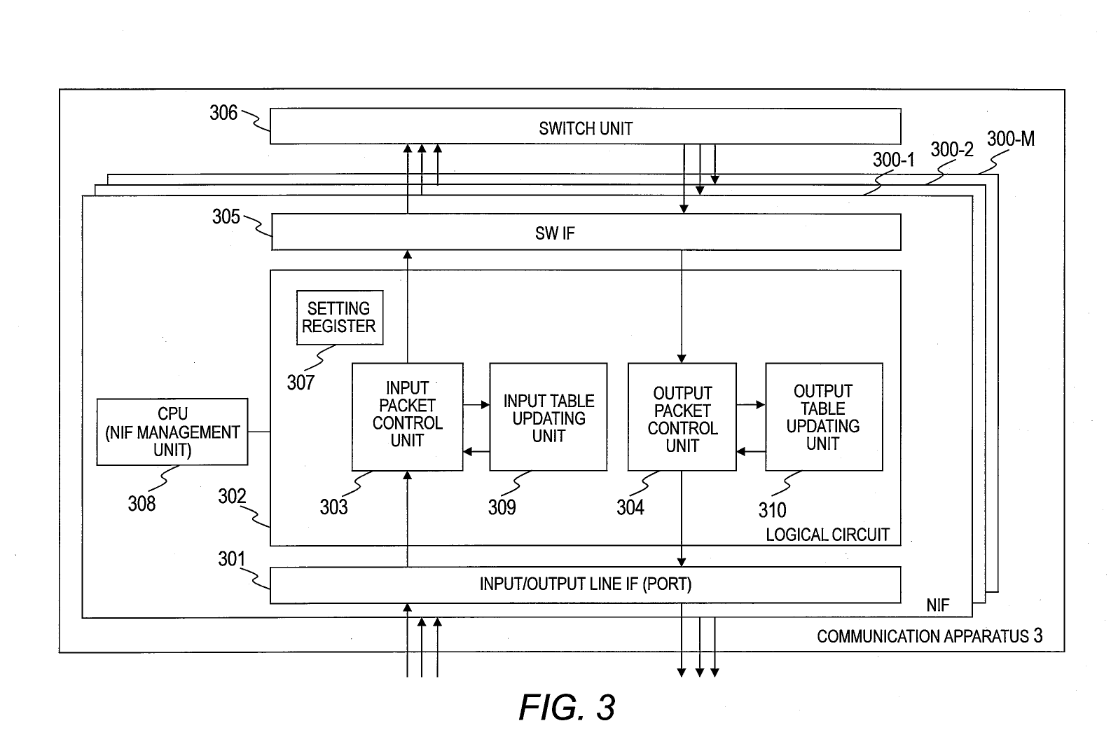

A first embodiment of this invention is described below with reference to FIGS. 3 to 14. The first embodiment is an example in which a computation function of the type of band control function is applied. The first embodiment omits a description on the method of band control, and a band control function in the first embodiment is described as a general computation function. A communication apparatus holds a computation result as computation information in a table, and updates the computation result each time a packet arrives. The communication apparatus configures a virtual multi-port RAM (virtual multi-port table) described below and executes table updating processing every clk in which two packets arrive. The virtual multi-port table includes a plurality of 1RD/1WR tables to implement one virtual 2RD/2WR table.

<Communication Apparatus Configuration Example>

FIG. 3 is a block diagram illustrating the physical configuration of and a logical circuit 302 of a communication apparatus according to the first embodiment. The communication apparatus which is denoted by 3 is an apparatus for transferring packets to another communication apparatus. The communication apparatus 3 includes a plurality of network interface boards (NIFs) 300-1 to 300-M (M is an arbitrary natural number) and a switch unit 306.

The NIFs 300 (300-1 to 300-M) are interfaces for receiving a packet from a network and transmitting a packet to the network. The switch unit 306 is an apparatus that is connected to the NIFs 300 to distribute packets received from one of the NIFs 300 to another of the NIFs 300 which is to send the packets.

The NIFs 300 each include an input/output line interface 301, the logical circuit 302, an SW interface 305, and an NIF management unit 308.

The input/output line interface 301 is a communication port. The communication apparatus 3 couples to another communication apparatus via the input/output line interface 301 and a network. The input/output line interface 301 in the first embodiment is, for example, a line interface for the Ethernet®.

The SW interface 305 is an apparatus for connecting to the switch unit 306. The NIF management unit 308 is, for example, a processor such as a CPU. The NIF management unit 308 controls processing in the logical circuit 302. The logical circuit 302 is a circuit that executes processing for packets according to first embodiment. The logical circuit 302 has at least one memory and at least one computing apparatus (for example, a processor).

The logical circuit 302 includes packet processing units, which are an input packet control unit 303, an output pocket control unit 304, an input table updating unit 309, an output table updating unit 310, and the like, and a setting register 307.

A packet received by the communication apparatus 3 is transmitted to the input/output line interface 301, the input packet control unit 303, the SW interface 305, the switch unit 306, the SW interface 305, the output packet control unit 304, and the input/output line interface 301 in the order stated. The packet passes through the input table updating unit 309 as a part of processing of the input packet control unit 303. Similarly, the packet passes through the output table updating unit 310 as a part of processing of the output packet control unit 304.

The processing units included in the logical circuit 302 may be implemented by physical apparatus such as integrated circuits, or may be implemented by programs that are executed by at least one processor. Out of the processing units of the logical circuit 302, a plurality of processing units (for example, the input packet control unit 303, the input table updating unit 309, the output packet control unit 304, and the output table updating unit 310) may be implemented by a single apparatus or a single program, or a single processing unit may be implemented by a plurality of apparatus or a plurality of programs.

The NIF management unit 308 controls the setting register 307. The setting register 307 has a storage area in which data is temporarily stored, and holds register values of the processing units included in the logical circuit 302.

The setting register 307 connects to the processing units included in the logical circuit 302 via the logical circuit 302. Although the specifics of processing executed by the setting register 307 are omitted from the following description, the processing units included in the logical circuit 302 use the setting register 307 to execute processing. The input/output line interface 301 attaches to a received packet an intra-apparatus header, which is described later.

The format of a packet is now described. A packet contains a destination MAC address, a source MAC address, a VLAN header, an Ethertype value, a payload, and a frame check sequence (FCS). The MAC address of the communication apparatus 3 is set as the destination MAC address or the source MAC address. A VLAN ID, which is the identifier of a flow, is set as the VLAN header.

Alternatively, a Multi-Protocol Label Switching (MPLS) label value or the like may be set as a flow identifier by setting an MPLS header or the header of other protocols in the payload. A value for detecting an error in the frame is set as the frame check sequence (FCS).

The format of the intra-apparatus header attached to a packet is described next. The intra-apparatus header includes an output network interface board identifier (output NIF ID), a flow ID, and a packet length. The output NIF ID is internal routing information. The internal routing information is information indicating which of the NIFs 300 in the communication apparatus 3 is used to output from its port a packet that has been received by the communication apparatus 3. The switch unit 306 follows the internal routing information in transferring an input packet that has been transmitted to the switch unit 306 to the SW interface 305 of the particular NIF 300.

The intra-apparatus header is attached by the input/output line interface 301 to a packet received by the communication apparatus 3 in order to process the received packet in the communication apparatus 3. In the following description, a packet to which the intra-apparatus header has been attached and which is transmitted from the input/output line interface 301 to the switch unit 306 is referred to as input packet.

When attaching the intra-apparatus header to a received packet, the input/output line interface 301 stores a null value or other similar values as the output NIF ID and the flow ID. In other words, the input/output line interface 301 does not determine values that are stored as the output NIF ID and the flow ID. It is the input packet control unit 303 that stores values as the output NIF ID and the flow ID.

The input/output line interface 301 obtains the packet length of the received packet and stores the obtained packet length as the frame length in the intra-apparatus header. The input/output line interface 301 then transmits the packet to the input packet control unit 303.

The input packet control unit 303 executes packet processing described later for the packet received from the input/output line interface 301. The input packet control unit 303 adds an output NIF ID and a flow ID to the intra-apparatus header in this packet processing.

The input packet control unit 303 also updates in this packet processing flow-by-flow packet information that is managed by the input table updating unit 309 with the use of tables. After the packet processing, the input packet control unit 303 transmits the input packet to the SW interface 305. The SW interface 305 transfers the received input packet to the switch unit 306.

The switch unit 306 receives an input packet from the SW interface 305 of each NIF 300, and then refers to the output NIF ID of the input packet to identify the NIF 300 that is the transfer destination of the received input packet. The switch unit 306 next transfers, as an output packet, the received input packet to the SW interface 305 of the identified NIF 300. In the first embodiment, a packet that is transmitted from the switch unit 306 to the input/output line interface 301 is referred to as output packet.

The SW interface 305 transfers the received output packet to the output packet control unit 304. While the packet processing is executed by the input packet control unit 303 in the example described above, the output packet control unit 304 may execute the packet processing instead of the input packet control unit 303. In the case where it is the output packet control unit 304 that executes the packet processing, the output packet control unit 304 transmits the output packet to the input/output line interface 301 after the packet processing. During the packet processing, the output packet control unit 304 updates flow-by-flow packet information that is managed by the output table updating unit 310 with the use of tables.

In the case where it is not the output packet control unit 304 that executes the packet processing, the output packet control unit 304 transfers the output packet received from the SW interface 305 to the input/output line interface 301 as it is, and does not update the flow-by-flow packet information that is managed by the output table updating unit 310.

The input/output line interface 301 removes the intra-apparatus header from the received output packet. Thereafter, the input/output line interface 301 transfers the output packet to another apparatus following the information that is included in the packet format described above.

<Configuration Example of the Input Packet Control Unit 303>

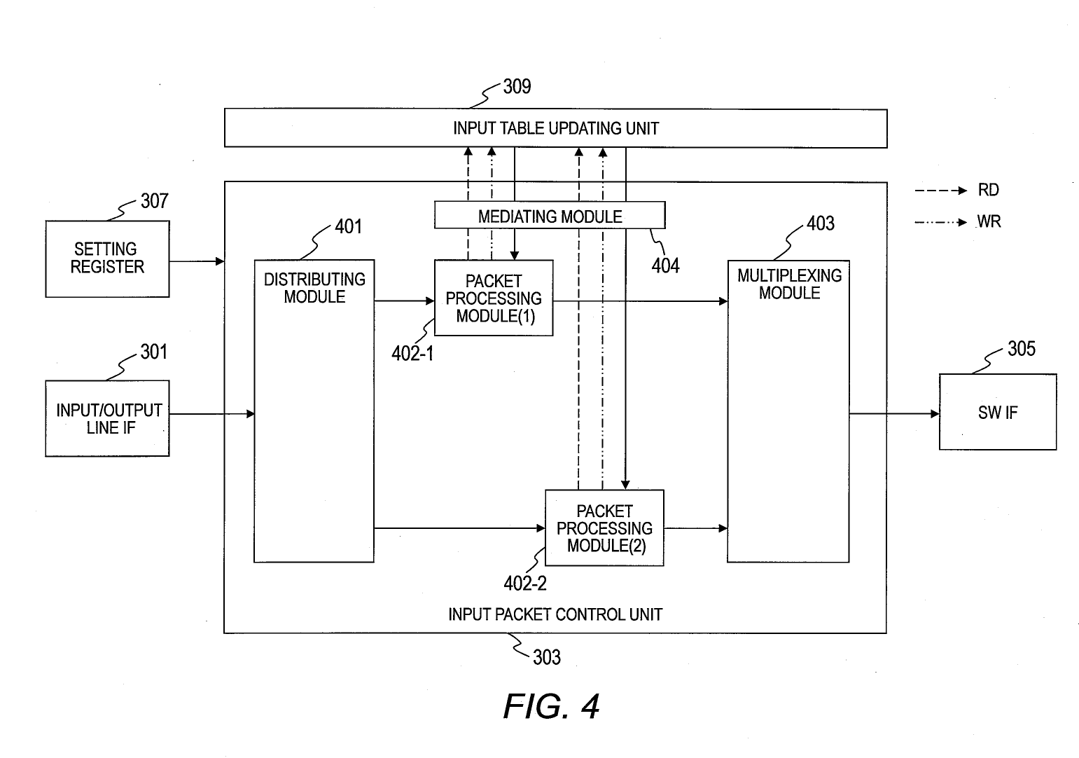

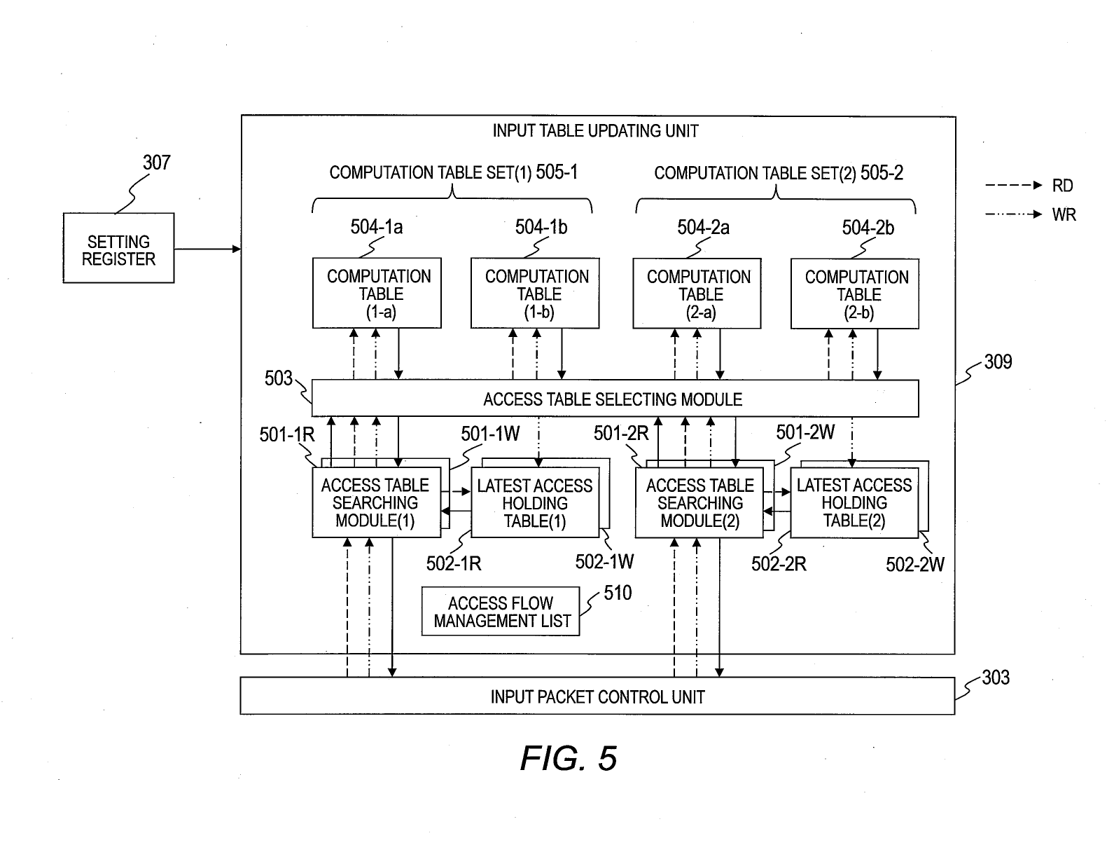

FIG. 4 is a block diagram illustrating the logical configuration of the input packet control unit 303 according to the first embodiment. In FIG. 4, the flow of an RD request and the flow of a WR request are expressed by a broken line and a double-dot-dash line, respectively (the same applies to broken lines and double-dot-dash lines in FIGS. 5, 16, 17, and 24, which are described later), in order to clarify the flows of an RD processing request and a WR processing request in the first embodiment.

The input packet control unit 303 includes a distributing module 401, two packet processing modules 402 (402-1 and 402-2), a multiplexing module 403, and a mediating module 404.

When the input packet control unit 303 receives an input packet from the input/output line interface 301, the distributing module 401 determines one of the packet processing modules 402-1 and 402-2 as the packet processing module 402 that executes the packet processing, and distributes the packet to the determined packet processing module 402.

The distributing module 401 identifies a flow of the received input packet based on the VLAN header of the packet, to thereby determine an output NIF ID. The distributing module 401 also stores values as the output NIF ID and the flow ID in the intra-apparatus header of each input packet, and transfer input packets to the packet processing modules 402 (402-1 and 402-2) in the order of reception of the packets.

The distributing module 401, which transfers input packets to the packet processing modules 402 (402-1 and 402-2) in the order of reception of the packets in the first embodiment, may determine the packet processing module 402 to which an input packet is to be transferred based on the identified flow of the packet. The distributing module 401 may also be designed so that, when one input packet is received, the packet is transferred to one of the packet processing modules 402 (for example, 402-1) whereas, when two input packets are received, one of the packets is transferred to one of the packet processing modules 402 (402-1 and 402-2) and the other packet is transferred to the other packet processing module 402.

The distributing module 401, which transfers packets to the packet processing modules 402 on an input packet-by-input packet basis here, may transfer fragments of an input packet, which are then rebuilt into the input packet by the multiplexing module 403. The distributing module 401 may also distribute only the header part (for example, from the destination MAC address to the Ether-type value) of an input packet to the packet processing modules 402, with the remaining payload part transferred to the multiplexing module 403 to wait for the completion of processing of the packet processing modules 402.

The packet processing module 402 that has a packet to process transfers an RD request and a WR request during packet processing to the mediating module 404, and updates a computation table held by the input table updating unit 309, which is described later. The packet processing module 402 transfers an RD request to the input table updating unit 309 in order to obtain information from the computation table. The packet processing module 402 transfers an RD address associated with a flow, along with the RD request. After obtaining the information, the packet processing module 402 executes computation processing, for example, consumed bandwidth calculation for the band control function, and transfers a WR request to the input table updating unit 309 in order to update the information of the computation table. The packet processing module 402 transfers a WR address that is associated with the flow and WR data with which the update is to be made, along with the WR request. After the packet processing, the packet processing module 402 transmits the input packet to the multiplexing module 403.

The packet processing module 402 may change the contents of a packet based on the result of the computation processing to transmit the changed packet to the multiplexing module 403. While the flow of a packet is identified by the distributing module 401 in the first embodiment, the packet processing module 402 may instead identify the flow of a packet and store values as the output NIF ID and the flow ID in the intra-apparatus header of the packet.

The mediating module 404 sorts RD requests and WR requests transferred from the packet processing modules 402 (402-1 and 402-2), and transfers the requests for the packet processing module 402-1 and the requests for the packet processing module 402-2 separately to the input table updating unit 309. In a similar fashion, the mediating module 404 receives an RD result for the packet processing module 402-1 and an RD result for the packet processing module 402-2 separately from the input table updating unit 309, and notifies the RD results to the packet processing modules 402 (402-1 and 402-2).

The packet processing modules 402, which executes computation processing of the band control function or the like in the first embodiment, may transfer packet information such as a flow ID and a packet length to the mediating module 404 so that the computation processing is executed by the mediating module 404. The mediating module 404 in this case obtains information from one of computation tables 504, and executes the computation processing to update the information of the computation table 504. In the case where the same flow ID is received from the packet processing module 402-1 and the packet processing module 402-2, the mediating module 404 may update the information of the computation tables 504 with an integrated computation result.

In the case where pieces of packet information of the same flow are received in succession, there is a possibility that an information update of the relevant computation table 504 has not been completed. The mediating module 404 therefore does not use information obtained from the computation table for the packet information received in this case, and may update information of the computation table with a computation result that has been held in the mediating module 404 since previous packet information processing.

The multiplexing module 403 multiplexes packets received from the respective packet processing modules 402, and transmits the multiplexed packets to the SW interface 305 in the order of arrival of the packets. The input packet control unit 303 in the first embodiment takes a predetermined time to finish packet processing. The number of the packet processing modules 402, which is two in the first embodiment to match the speed of a line to which the communication apparatus 3 is coupled (the number of packets that arrive simultaneously), may instead be N (N is an arbitrary natural number). The mediating module 404 in this case performs mediation in which N groups of RD, requests and WR requests transferred from the packet processing modules 402 are sorted into two groups of RD requests and WR requests, and transfers the two groups of requests to the input table updating unit 309.

<Configuration Example of Input Table Updating Unit 309>

FIG. 5 is a block diagram illustrating the logical configuration of the input table updating unit 309 according to the first embodiment. The input table updating unit 309 includes access table searching modules 501 (501-1 and 501-2), latest access holding tables 502 (502-1 and 502-2), an access table selecting module 503, the computation tables 504 (504-1a, 504-1b, 504-2a, and 504-2b), and an access flow management list 510.

“Computation table set 505-1” is a collective term for the computation tables 504-1a and 504-1b. “Computation table set 505-2” is a collective term for the computation tables 504-2a and 504-2b. In the first embodiment, those four computation tables 504 (504-1a, 504-1b, 504-2a, and 504-2b) which are each a 1RD/1WR table constitute a virtual multi-port table, which implements one virtual 2RD/2WR computation table.

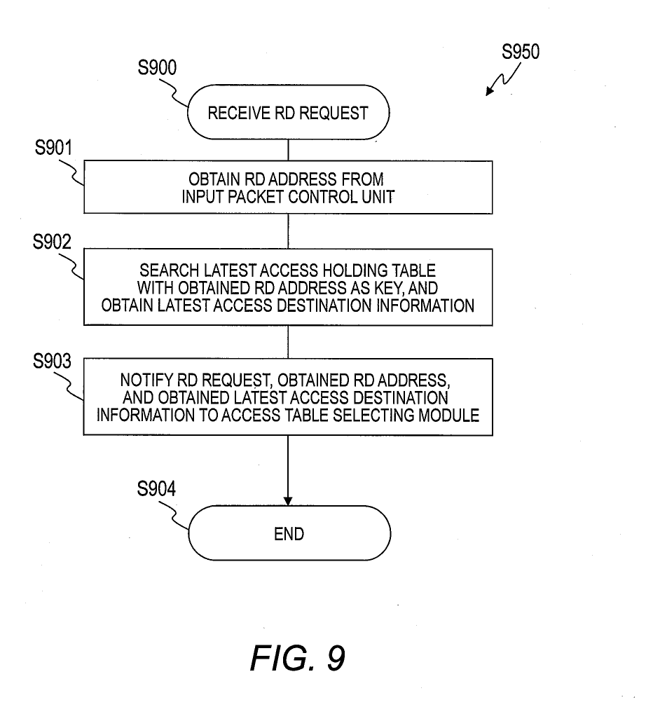

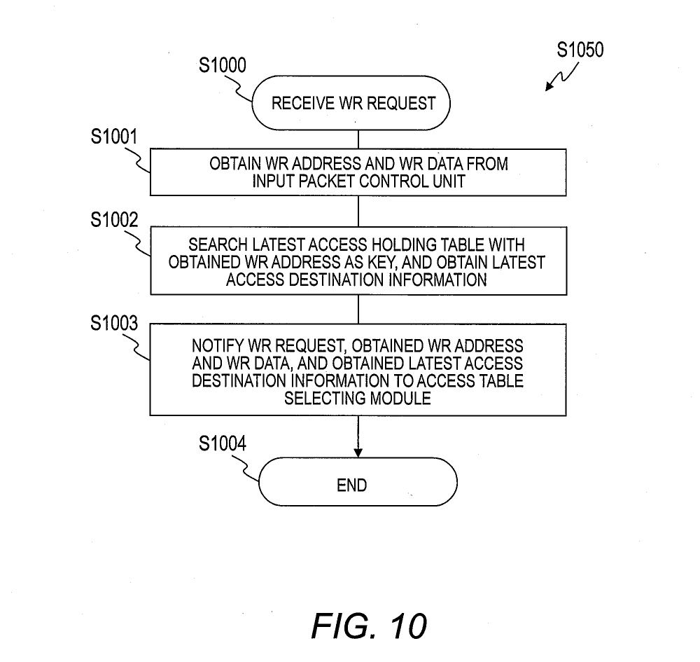

The access table searching modules 501 (501-1R and 501-2R) are processing modules for receiving RD requests from the input packet control unit 303 and then referring to the latest access holding tables 502 (502-1R and 502-2R) to execute RD access table searching processing S950, which is described later with reference to FIG. 9. The access table searching modules 501 (501-1W and 501-2W) are processing modules for receiving WR requests from the input packet control unit 303 and then referring to the latest access holding tables 502 (502-1W and 502-2W) to execute WR access table searching processing S1050, which is described later with reference to FIG. 10. The access table searching modules 501 notify latest access destination information that is retrieved from the latest access holding tables 502 to the access table selecting module 503.

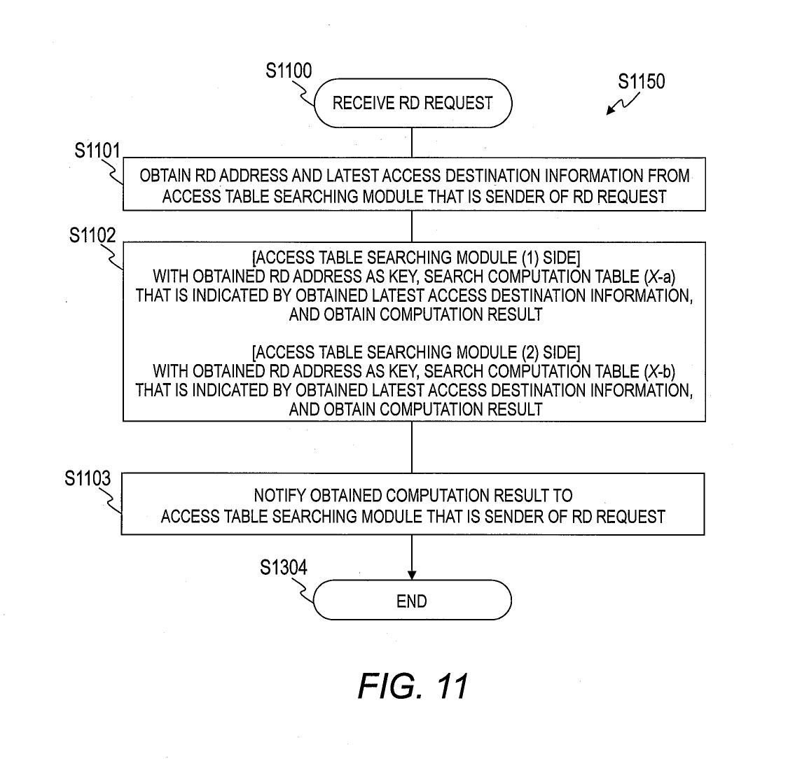

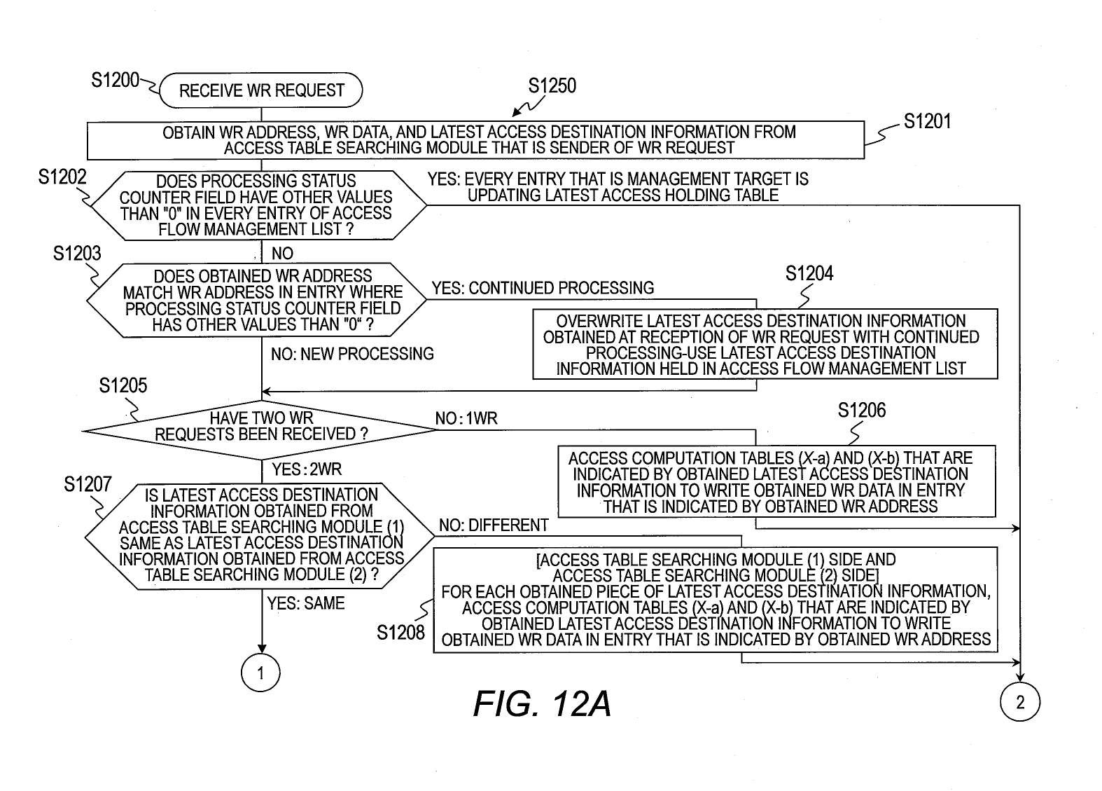

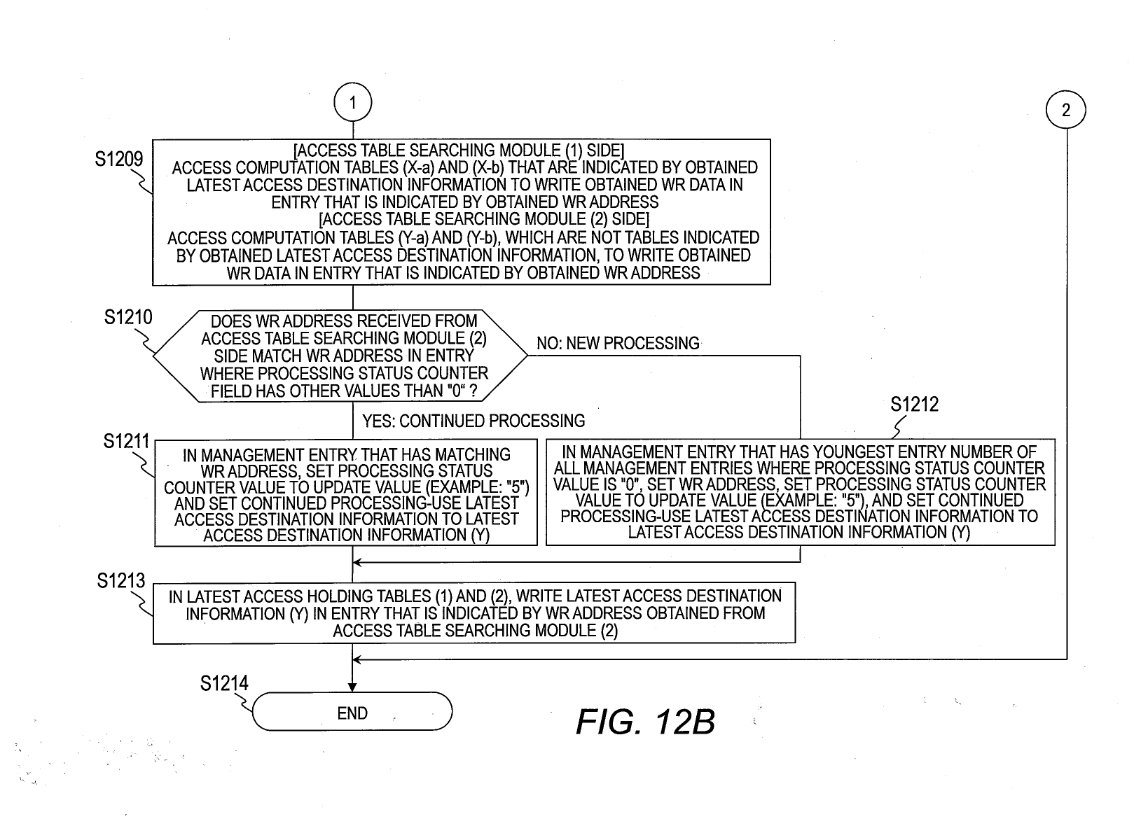

The access table selecting module 503 is a processing module for receiving RD requests from the access table searching modules 501 and then executing RD access table selecting processing S1150, which is described later with reference to FIG. 11, to read information out of the computation tables 504. The access table selecting module 503 is also a processing module for receiving WR requests from the access table searching modules 501 and then executing WR access table selecting processing S1250, which is described later with reference to FIG. 12, to write information in the computation tables 504.

The access table selecting module 503 uses latest access destination information that is received from one of the access table searching modules 501 at the same time as an RD request or a WR request, to select one of the computation tables 504 out of which data is to be read or one of the computation tables 504 in which data is to be written. In the case where one of the computation tables 504 (the computation table sets 505) to which a write is to be made is changed from a computation table set that is indicated by latest access destination information received at the same time as a WR request, the access table selecting module 503 writes back the result of the change to the latest access holding tables 502-1 (502-1R and 502-1W) and the latest access holding tables 502-2 (502-2R and 502-2W) both.

The access flow management list 510 shows the WR address of an input packet for which the access table selecting module 503 is executing the WR access table selecting processing S1250, the processing status of the access table selecting module 503, and latest access destination information for continued processing.

The input table updating unit 309 keeps the access flow management list 510 in a memory that is included in the logical circuit 302, or in a similar place, and manages the access flow management list 510 through access flow management processing S1350. The access table selecting module 503 updates the access flow management list 510 in the WR access table selecting processing S1250.

<Example of Information Stored in the Latest Access Holding Tables 502>

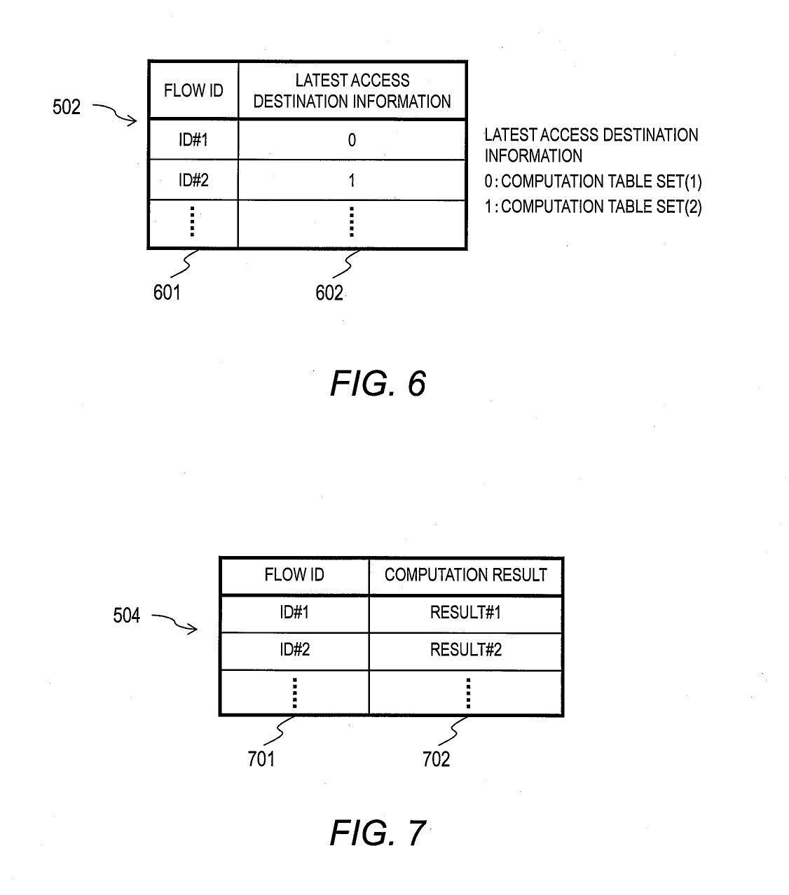

FIG. 6 is an explanatory diagram illustrating the latest access holding tables 502 of the first embodiment. The latest access holding tables 502 are tables holding information about which of the computation tables 504 (504-1a, 504-1b, 504-2a, and 504-2b) (here, managed as the computation table sets 505) is a table where the latest flow-by-flow information is written with respect to a packet received by the communication apparatus 3. The latest access holding tables 502 each include a flow ID field 601 and a latest access destination information field 602, and store the values of the respective fields 601 and 602 for each flow.

The flow ID field 601 contains the flow ID of an input packet. The latest access destination information field 602 contains information specifying a computation table set that holds flow-by-flow latest information of a computation result with respect to the packet. In the latest access destination information field 602, a value “0” indicates the computation table set 505-1 and a value “1” indicates the computation table set 505-2. The latest access holding tables 502 are updated in Step S1213 of FIG. 12B.

<Example of Information Stored in the Computation Tables 504>

FIG. 7 is an explanatory diagram illustrating the computation tables 504 of the first embodiment. The computation tables 504 each include a flow ID field 701 and a computation result field 702, and store the values of the respective fields 701 and 702 for each flow. The flow ID field 701 contains the flow ID of an input packet. The computation result field 702 contains a flow-by-flow computation result of computation processing of the band control function in the input packet control unit 303, or other similar types of computation processing.

<Example of Information Stored in the Access Flow Management List 510>

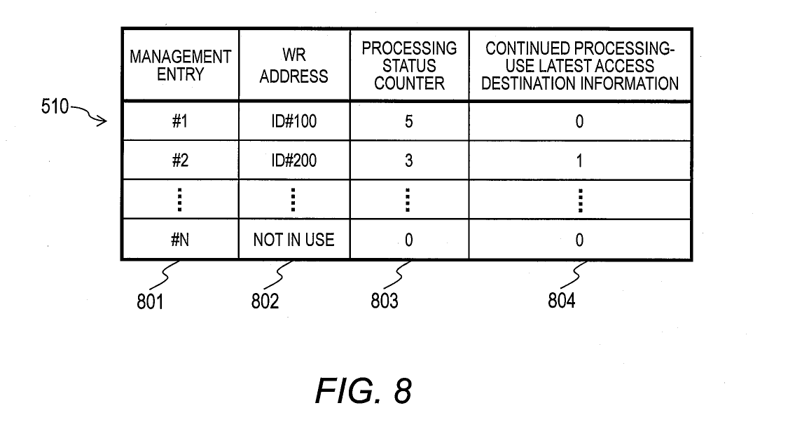

FIG. 8 is an explanatory diagram illustrating the access flow management list 510 of the first embodiment. The access flow management list 510 includes a management entry field 801, a WR address field 802, a processing status counter field 803, and a continued processing-use latest access destination information field 804, and stores the values of the respective fields 801 to 804 for each management entry.

The management entry field 801 contains an identifier uniquely indicating an entry (one of 1 to N) of an internal logical circuit that manages a flow for which the relevant computation table 504 is being updated (hereinafter referred to as management entry). The management entry is, for example, a value that identifies the internal logical circuit by a numerical value. A value stored in the management entry field 801 is set in advance by an administrator or others.

The WR address field 802 contains an address uniquely indicating a flow that is assigned to an input packet. A value stored in the WR address field 802 is an address that is associated with the value of a flow ID identified in the input packet control unit 303. The value stored in the WR address field 802 is updated by the access table selecting module 503.

The processing status counter field 803 stores a count counted by a processing status counter. The count by the processing status counter includes a value that indicates the status of a write in the latest access holding tables 502-1 and 502-2. The count by the processing status counter includes a value that indicates the status of a write in the latest access holding tables 502-1 and 502-2 in the case where the latest access destination information is changed based on a WR request received from, for example, the access table searching module (2) in the WR access table selecting processing S1250 of the access table selecting module 503.

More specifically, the processing status counter field 803 contains, for example, a value about an execution time from the start of processing of writing in the latest access holding tables 502-1 and 502-2 till the write is actually reflected on the latest access destination information field 602 in the latest access holding tables 502-1 and 502-2.

The count by the processing status counter described below indicates a remaining time till a write is reflected on the latest access destination information field 602 which is counted by a count-down counter since the start of the processing of writing in the latest access holding tables 502-1 and 502-2. Specifically, a processing time is stored in the processing status counter field 803 when the write processing is started.

Subsequently, the input table updating unit 309 subtracts from the value of the processing status counter field 803 each time a unit time (one clk in the first embodiment) elapses. A value “0” stored in the processing status counter field 803 indicates that the access table selecting module 503 has finished the write processing described above for the management entry in question, and that the write has been reflected on the latest access destination information field 602. A positive number other than “0” stored in the processing status counter field 803 indicates that the write processing is being executed for the management entry in question at a WR address associated with the relevant flow ID, and that the write has not been reflected on the latest access destination information field 602.

Processing that is executed in the case where the processing status counter is a count-down counter is described below. The processing status counter may instead be a count-up counter to indicate the time elapsed since the start of write processing. The access table selecting module 503 in this case may obtain the status of write processing through a comparison between a given length of time and a count counted by the processing status counter.

The following is a description of RD access table searching processing S950, which is executed by the access table searching modules 501.

<RD Access Table Searching Processing S950>

FIG. 9 is a flow chart illustrating the RD access table searching processing S950, which is executed by the access table searching modules 501 of the first embodiment. The access table searching modules 501 (501-1R and 501-2R) receive RD requests from the input packet control unit 303 (S900), and obtain RD addresses that are received at the same time as the RD requests from the input packet control unit 303 (S901). After Step S901, the access table searching modules 501 (501-1R and 501-2R) search the latest access holding tables 502 (502-1R and 502-2R) with the obtained RD addresses as keys, and obtain pieces of latest access destination information (S902). After Step S902, the access table searching modules 501 (501-1R and 501-2R) notify the RD requests, the RD addresses obtained in Step S901, and the pieces of latest access destination information obtained in Step S902 to the access table selecting module 503, and end the RD access table searching processing S950 (S904).

The access table searching modules 501-1R and 501-2R in the first embodiment start the RD access table searching processing S950 with RD requests respectively received from the input packet control unit 303 as a trigger, and notify pieces of latest access destination information obtained from the latest access holding tables 502-1R and 502-2R which are included in the access table searching modules 501-1R and 501-2R, respectively, to the access table selecting module 503.

The following is a description of WR access table searching processing S1050, which is executed by the access table searching modules 501.

<WR Access Table Searching Processing S1050>

FIG. 10 is a flow chart illustrating the WR access table searching processing S1050, which is executed by the access table searching modules 501 of the first embodiment. The access table searching modules 501 (501-1W and 501-2W) receive WR requests from the input packet control unit 303 (S1000), and obtain WR addresses that are received at the same time as the WR requests from the input packet control unit 303 (S1001). After Step S1001, the access table searching modules 501 (501-1W and 501-2W) search the latest access holding tables 502 (502-1W and 502-2W) with the obtained WR addresses as keys, and obtain pieces of latest access destination information (S1002).

After Step S1002, the access table searching modules 501 (501-1W and 501-2W) notify the WR requests, the WR addresses and WR data obtained in Step S1001, and the pieces of latest access destination information obtained in Step S1002 to the access table selecting module 503, and end the WR access table searching processing S1050 (S1004).

The access table searching modules 501-1W and 501-2W in the first embodiment start the WR access table searching processing S1050 with WR requests respectively received from the input packet control unit 303 as a trigger, and notify pieces of latest access destination information obtained from the latest access holding tables 502 (502-1W and 502-2W) which are included in the access table searching modules 501-1W and 501-2W, respectively, to the access table selecting module 503.

The following is a description on RD access table selecting processing S1150, which is executed by the access table selecting module 503 of the first embodiment.

<RD Access Table Selecting Processing S1150>

FIG. 11 is a flow chart illustrating the RD access table selecting processing S1150, which is executed by the access table selecting module 503 of the first embodiment. When receiving an RD request from at least one of the access table searching modules 501 (501-1R and 501-2R) (S1100), the access table selecting module 503 obtains an RD address and latest access destination information that are received at the same time as the RD request from the access table searching module 501 (501-1R or 501-2R) (S1101).

After Step S1101, the access table selecting module 503 uses the RD address obtained in Step S1101 as a key to search the computation table 504 (one of 504-1a, 504-1b, 504-2a, and 504-2b) that is indicated by the latest access destination information obtained in Step S1101, and obtains a computation result (S1102).

In the case where the RD request obtained in Step S1100 is from the access table searching module 501-1R, the access table selecting module 503 in the first embodiment accesses the computation table set 505-X that is indicated by the latest access destination information obtained in Step S1101, and searches the set's a-side computation table (X-a) 504-Xa. The symbol X represents 1 or 2, and indicates the computation table set 505-1 or 505-2.

In the case where the RD request obtained in Step S1100 is from the access table searching module 501-2R, the access table selecting module 503 accesses the computation table set 505-X that is indicated by the latest access destination information obtained in Step S1101, and searches the set's b-side computation table (X-b) 504-Xb.

In Step S1102, the access table selecting module 503 searches separate computation tables 504 to process RD requests that are received simultaneously from the access table searching module 501-1R and the access table searching module 501-2R. The virtual multi-port table of the first embodiment which constitutes one virtual 2RD/2WR computation table can thus process two RD requests concurrently.

In the first embodiment, RD requests of the access table searching module 501-1R are associated with the computation table 504-Xa and RD requests of the access table searching module 501-2R are associated with the computation table 504-Xb. This association may be inversed to associate RD requests of the access table searching module 501-1R with the computation table 504-Xb and RD requests of the access table searching module 501-2R with the computation table 504-Xa.

The access table selecting module 503 in the first embodiment can search any one of the computation table 504-Xa and the computation table 504-Xb to process an RD request in the case where RD requests are not received simultaneously from the access table searching module 501-1R and the access table searching module 501-2R (i.e., in the case where only one RD request is received), or in the case where RD requests are received simultaneously from the access table searching module 501-1R and the access table searching module 501-2R but different computation table sets 505-X are indicated by the obtained pieces of latest access destination information.

After Step S1102, the access table selecting module 503 notifies the computation result obtained in Step S1102 to the access table searching module 501 (501-1R or 501-2R) that is the sender of the RD request (S1103), and ends the RD access table selecting processing S1150 (S1104). The access table searching module 501 (501-1R or 501-2R) notifies the computation result notified in Step S1103 to the input packet control unit 303 as RD data, to thereby complete RD to the relevant computation table 504 in the input packet control unit 303.

Given below with reference to FIGS. 12A and 12B is a description on WR access table selecting processing S1250, which is executed by the access table selecting module 503 of the first embodiment.

<WR Access Table Selecting Processing S1250>

FIG. 12A is a flow chart (first half) illustrating a detailed processing procedure example of the WR access table selecting processing S1250, which is executed by the access table selecting module 503 of the first embodiment. FIG. 12A illustrates processing for the case where one WR request is received, and processing for the case where two WR requests are received and pieces of latest access destination information associated with the two WR requests are different from each other.

When receiving a WR request from at least one of the access table searching modules 501 (501-1W and 501-2W) (S1200), the access table selecting module 503 obtains a WR address, WR data, and latest access destination information that are received at the same time as the WR request from the access table searching module 501 (501-1W or 501-2W) (S1201).

After Step S1201, the access table selecting module 503 determines whether or not the processing status counter field 803 has other values than “0” for every management entry registered in the management entry field 801 of the access flow management list 510 (S1202).

When it is determined in Step S1202 that the processing status counter value is other than “0” for every management entry in the access flow management list 510 (Step S1202: Yes), all management entries (1 to N) are executing processing of writing in the latest access holding tables 502-1W and 502-2W. This means that write processing that is requested by a new WR request cannot be granted. Accordingly, the access table selecting module 503 proceeds to processing of FIG. 12B and ends the WR access table selecting processing S1250 (S1214).

When it is found in Step S1202 that management entries of the access flow management list 510 include at least one management entry whose processing status counter value is “0” (Step S1202: No), at least one entry out of all management entries (1 to N) is not executing processing of writing to the latest access holding tables 502-1W and 502-2W. This means that write processing that is requested by a new WR request can be granted, and the access table selecting module 503 accordingly proceeds to Step S1203.

In the case where WR requests have been received simultaneously from the access table searching module 501-1W and the access table searching module 501-2W in Step S1200, the access table selecting module 503 checks in Step S1202 whether a management entry is capable of processing of a plurality of entries (two entries).

In the case where a management entry whose processing status counter value is “0” out of the management entries of the access flow management list 510 is capable of processing of the plurality of entries received in Step S1200, the access table selecting module 503 proceeds to Step S1203. In the case where the management entry whose processing status counter value is “0” is not capable of processing of the plurality of entries received in Step S1200, the access table selecting module 503 proceeds to the processing of FIG. 12B and ends the WR access table selecting processing S1250 illustrated in FIGS. 12A and 12B.

Alternatively, in the case where the management entry whose processing status counter value is “0” is not capable of processing of the plurality of entries received in Step S1200, the access table selecting module 503 may proceed to Step S1203 to process a WR request for the management entry whose processing status counter value is “0”, and proceed to the processing of FIG. 12B to process the rest of WR requests and end the WR access table selecting processing S1250 illustrated in FIG. 12A and FIG. 12B.

In Step S1203, the access table selecting module 503 determines whether or not the value of the WR address obtained in Step S1201 matches the value of the WR address in a management entry whose processing status counter value is other than “0” (S1203).

The access table selecting module 503 may determine in Step S1203 that the value of the WR address obtained in Step S1201 matches the value of the WR address in a management entry whose processing status counter value is other than “0” in the case where a value associated with the value of the obtained WR address matches the value of the WR address in the management entry whose processing status counter value is other than “0”.

When it is determined in Step S1203 that the value of the WR address obtained in Step S1201 does not match the value of the WR address in a management entry that holds other values than “0” in the processing status counter field 803 (S1203: No), the obtained WR request is of a flow where processing of writing in the latest access holding tables 502-1W and 502-2W is not being executed. Accordingly, the access table selecting module 503 uses the latest access destination information obtained in Step S1201 and proceeds to Step S1205.

When it is determined in Step S1203 that the value of the WR address obtained in Step S1201 matches the value of the WR address in a management entry whose processing status counter value is other than “0” (S1203: Yes), on the other hand, it means that the obtained WR request is of a flow where processing of writing in the latest access holding tables 502-1W and 502-2W is being executed. Accordingly, the access table selecting module 503 overwrites the latest access destination information obtained in Step S1201 with the value of the continued processing-use latest access destination information field 804 that is associated with the value of the management entry field 801 that indicates a management entry whose WR address matches the obtained WR address, and keeps the updated information (S1204). The access table selecting module 503 then proceeds to Step S1205.

The access table selecting module 503 then determines whether or not two WR requests have been received in Step S1200 (S1205). When it is determined in Step S1205 that the number of WR requests received in Step S1200 is not two (Step S1205: No), one WR request has been received in Step S1200 by the access table selecting module 503. The access table selecting module 503 therefore accesses the a-side and b-side computation tables 504 (504-Xa and 504-Xb) of the computation table set 505-X that is indicated by the latest access destination information obtained in Step S1201, or by the latest access destination information written in Step S1204 as an overwrite, to write the obtained WR data in an entry that is indicated by the WR address obtained in Step S1201 (S1206). The symbol X represents 1 or 2, and indicates the computation table set 505-1 or 505-2.

In the first embodiment, the access table selecting module 503 updates the a-side and b-side computation tables 504 (504-Xa and 504-Xb) that are included in one computation table set 505 with the same WR data, thereby synchronizing information between tables in the same computation table set 505. With the computation tables 504 of the computation table set 505 synchronized with each other in Step S1102 of the RD access table selecting processing S1150 described above, this ensures that searching any one of the a-side computation table 504 and the b-side computation table 504 yields the same information.

After Step S1206, the access table selecting module 503 proceeds to the processing of FIG. 12B and ends the WR access table selecting processing S1250 illustrated in FIGS. 12A and 12B (S1214).

In the case where it is determined in Step S1205 that two WR requests have been received in Step S1200 (Step S1205: Yes), on the other hand, the number of WR requests received in Step S1200 by the access table selecting module 503 is two. Then, the access table selecting module 503 determines whether or not the latest access destination information that is associated with a WR request received from the access table searching module (1) 501-1W (the information obtained in Step S1201 or written in Step S1204 as an overwrite) matches the latest access destination information that is associated with a WR request received from the access table searching module (2) 501-2W (the information obtained in Step S1201 or written in Step S1204 as an overwrite) (S1207).

When it is determined in Step S1207 that the latest access destination information that is associated with the WR request received from the access table searching module (1) 501-1W does not match the latest access destination information that is associated with the WR request received from the access table searching module (2) 501-2W (Step S1207: No), it means that different computation table sets 505 are about to be updated to process the two WR requests. Accordingly, for each piece of latest access destination information obtained, the access table selecting module 503 accesses the a-side and b-side computation tables 504 (504-Xa and 504-Xb) of the computation table set 505-X that is indicated by the latest access destination information to write the obtained WR data in an entry that is indicated by the WR address obtained in Step S1201 (S1208).

When it is determined in Step S1207 that the latest access destination information that is associated with the WR request received from the access table searching module (1) 501-1W matches the latest access destination information that is associated with the WR request received from the access table searching module (2) 501-2W (Step S1207: Yes), on the other hand, it means that the same computation table set 505 is about to be updated to process the two WR requests. Accordingly, the access table selecting module 503 proceeds to Step S1209 of FIG. 12B, where, in order to avoid contention, different computation table sets 505 are selected as the computation table sets 505 to be updated to process the two WR requests.

FIG. 12B is a flow chart (second half) illustrating a detailed processing procedure example of the WR access table selecting processing S1250, which is executed by the access table selecting module 503 of the first embodiment. FIG. 12B illustrates, in the WR access table selecting processing S1250, which is executed by the access table selecting module 503 of the first embodiment, processing for the case where two WR requests are received and pieces of latest access destination information associated with the two WR requests are the same.

In Step S1209, the access table selecting module 503 processes the WR request that has been received from the access table searching module (1) 501-1W by accessing the a-side and b-side computation tables 504 (504-Xa and 504-Xb) of the computation table set 505-X that is indicated by the obtained latest access destination information, and writing the obtained WR data in an entry that is indicated by the WR address obtained in Step S1201.

To process the WR request that has been received from the access table searching module (2) 501-2W, on the other hand, the access table selecting module 503 accesses the a-side and b-side computation tables 504 (504-Ya and 504-Yb) of the computation table set 505-Y, which is not the computation table set 505-X indicated by the obtained latest access destination information, to write the obtained WR data in an entry that is indicated by the WR address obtained in Step S1201 (S1209). The symbol Y represents 1 or 2 and indicates the computation table set 505-1 or 505-2. The value of Y differs from the value of X.

The access table selecting module 503 processes in Step S1209 WR requests that are received simultaneously from the access table searching module 501-1W and the access table searching module 501-2W by respectively updating the computation tables 504 that are included in separate computation table sets 505. For each of the WR requests, WR data of the WR request can thus be held in one computation table set 505. This enables the virtual multi-port table of the first embodiment which constitutes one virtual 2RD/2WR computation table to process two WR requests concurrently.

After Step S1209, the access table selecting module 503 determines whether or not the WR address received from the access table searching module (2) 501-2W matches the WR address value in a management entry where the processing status counter value is other than “0” (S1210).

When it is determined in Step S1210 that the WR address received from the access table searching module (2) 501-2W matches the WR address value in a management entry where the processing status counter value is other than “0” (Step S1210: Yes), the access table selecting module 503 updates the processing status counter value of the management entry that has the matching WR address with a value that indicates the write time. In the case where the write time is 5 clk, for example, the access table selecting module 503 updates the processing status counter value of the management entry that is a match to “5”. The access table selecting module 503 also updates the value of the continued processing-use latest access destination information that is associated with the value of the management entry field 801 that indicates the management entry having the matching WR address with the value of Y selected in Step S1209 (S1211).

An update made to the processing status counter value of a management entry by the access table selecting module 503 indicates that the management entry has not finished the processing of writing in the latest access holding tables 502-1 and 502-2 and is still executing the write processing. Updating the continued processing-use latest access destination information of a management entry enables the access table selecting module 503 to maintain the registered latest access destination information in Step S1204 of FIG. 12A even when a WR request having the same WR address arrives before the management entry finishes the processing of writing in the latest access holding tables 502-1 and 502-2, and to select, based on the maintained latest access destination information, the computation table set 505 that is to be accessed for a WR. After Step S1211, the access table selecting module 503 proceeds to Step S1213.

In the case where it is found in Step S1210 that the WR address received from the access table searching module (2) 501-2W does not match the WR address value in a management entry where the processing status counter value is other than “0” (Step S1210: No), on the other hand, the access table selecting module 503 extracts an entry that has the lowest entry number (the smallest entry number) of management entries on the access flow management list 510 that have “0” as the processing status counter value. The access table selecting module 503 determines the extracted management entry as an internal logical circuit that newly executes processing related to the WR request.

The access table selecting module 503 then updates the WR address of the extracted management entry with the value of the WR address obtained from the access table searching module (2) 501-2W in Step S1201. The access table selecting module 503 updates the processing status counter value of the extracted management entry with a value that indicates the write time. The access table selecting module 503 updates the value of the continued processing-use latest access destination information of the extracted management entry with the value of Y selected in Step S1209 (S1212).

In Step S1212, the access table selecting module 503 selects an entry that has the lowest entry number of the management entries on the access flow management list 510 that have “0” as the processing status counter value. However, the access table selecting module 503 can follow any rule in extracting an entry as long as the extracted entry is one of management entries on the access flow management list 510 that have “0” as the processing status counter value. For instance, the access table selecting module 503 may extract an entry that has the highest entry number (the largest entry number), or may extract an entry in an order that is determined by an administrator in advance.

After Step S1212, the access table selecting module 503 proceeds to Step S1213. In Step S1213, the access table selecting module 503 accesses the latest access holding tables 502-1R, 502-1W, 502-2R, and 502-2W to write the value of Y selected in Step S1209 in an entry (flow ID) that is indicated by the value of the WR address obtained from the access table searching module (2) 501-2W in Step S1201.

This enables the access table selecting module 503 to notify a change in latest access destination information to the access table searching modules 501. A change in latest access destination information involves processing a WR request received from the access table searching module (2) 501-2W by writing the requested WR data in the computation tables 504 (504-Ya and 504-Yb) that are included in the computation table set 505-Y. Step S1213 also enables the access table searching module 501 to process a subsequently received RD request or WR request by obtaining the changed information in the RD access table searching processing S950 or the WR access table searching processing S1050.

In the first embodiment, when it is determined that the latest access destination information that is associated with the WR request received from the access table searching module (1) 501-1W is the same as the latest access destination information that is associated with the WR request received from the access table searching module (2) 501-2W, the latest access destination information that is associated with the WR request received from the access table searching module (2) 501-2W is changed (from the computation table set 505-X to the computation table set 505-Y) (S1209 to S1213). Alternatively, the access table selecting module 503 may process the WR request received from the access table searching module (1) 501-1W by changing the latest access destination information that is associated with the WR request received from the access table searching module (1) 501-1W to avoid contention within the same computation table set 505.

After Step S1213, the access table selecting module 503 ends the WR access table selecting processing S1250 illustrated in FIGS. 12A and 12B (S1214).

The following is a description on access flow management processing S1350, which is executed by the input table updating unit 309.

<Access Flow Management Processing S1350>

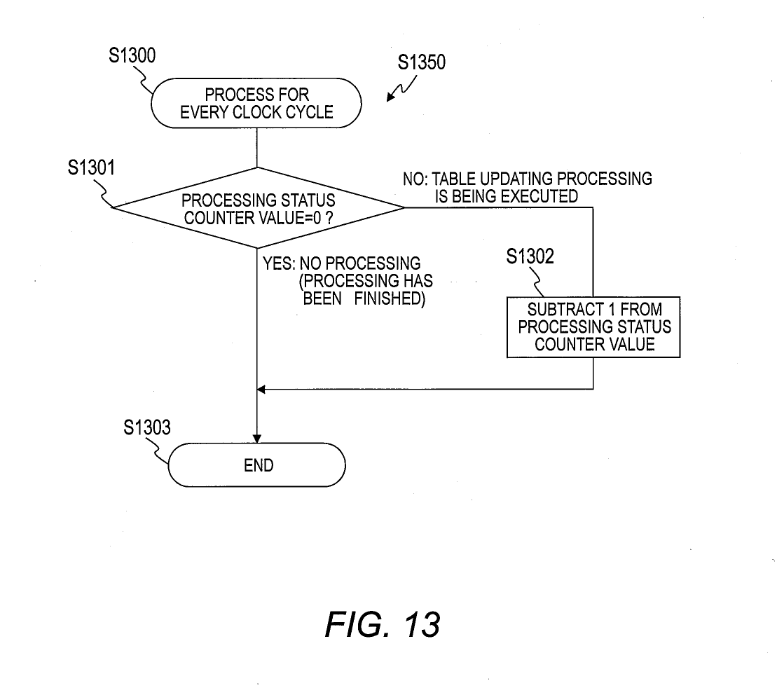

FIG. 13 is a flow chart illustrating the access flow management processing S1350, which is executed by the input table updating unit 309 of the first embodiment. The input table updating unit 309 determines, every clock cycle (S1300), whether or not the value of the processing status counter field 803 is “0” in every entry of the access flow management list 510 (S1301).

When it is determined in Step S1301 that the value of the processing status counter field 803 is “0” in every entry of the access flow management list 510 (S1301: Yes), the input table updating unit 309 ends the access flow management processing S1350 (S1303).

When it is determined in Step S1301 that not every entry of the access flow management list 510 has “0” as the value of the processing status counter field 803 (S1301: No), on the other hand, the input table updating unit 309 subtracts 1 from the value of the processing status counter field 803 in each cell in the field of the processing status counter field 803 that holds other values than “0” (S1302). After Step S1302, the input table updating unit 309 ends the access flow management processing S1350 (S1303).

Given below is an example of computation results changed by table updating processing according to the first embodiment.

<Table Updating Processing Example>

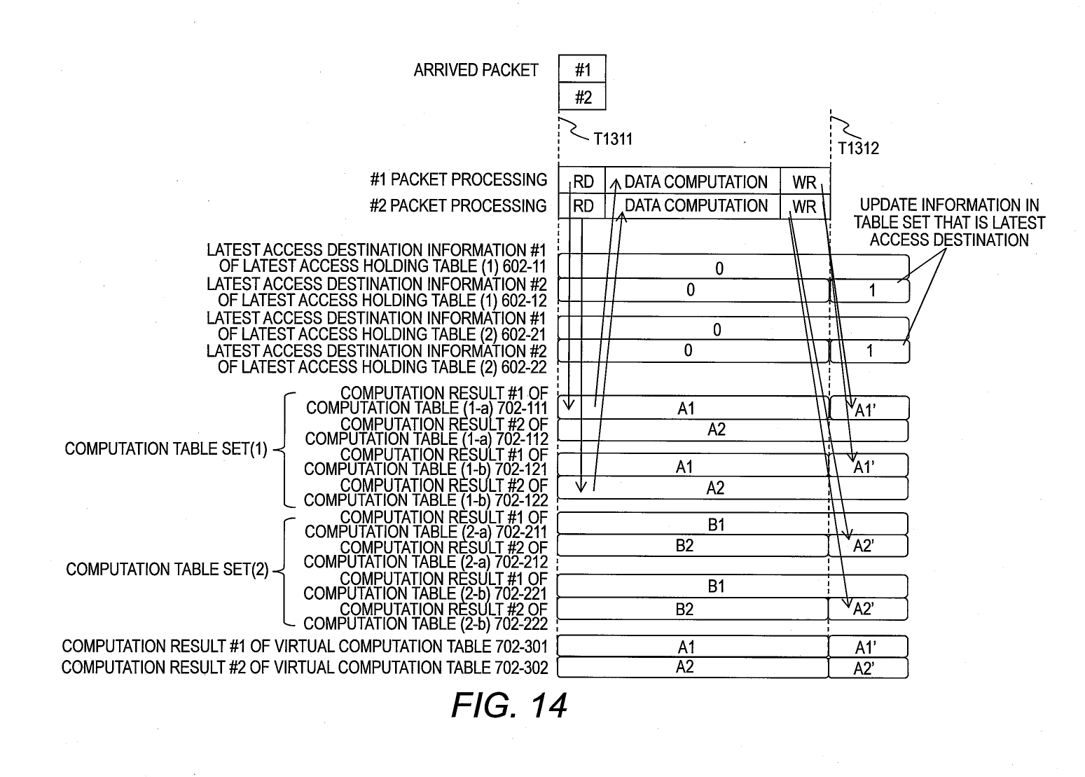

FIG. 14 is an explanatory diagram illustrating computation results that are produced when table updating processing of the first embodiment is executed. Illustrated in FIG. 14 is an example of how computation results change when the table updating processing is executed in the case where two packets arrive in one clk and pieces of information about the two packets are stored in the same computation table set 505. In the first embodiment, two input packets received by the input packet control unit 303 are referred to as a first packet (which has a flow ID “#1”) and a second packet (which has a flow ID “#2”).

In FIG. 14, latest access destination information 602-11 is the latest access destination information value of an entry that holds “#1” as the flow ID in the latest access holding tables 502-1 (502-1R and 502-1W). Latest access destination information 602-12 is the latest access destination information value of an entry that holds “#2” as the flow ID in the latest access holding tables 502-1 (502-1R and 502-1W).

Latest access destination information 602-21 is the latest access destination information value of an entry that holds “#1” in the flow ID field 601 in the latest access holding tables 502-2 (502-2R and 502-2W). Latest access destination information 602-22 is the latest access destination information value of an entry that holds “#2” as the flow ID in the latest access holding tables 502-2 (502-2R and 502-2W).

In FIG. 14, a computation result 702-111 is the value of a computation result of the computation table 504-1a in which the flow ID is “#1”. A computation result 702-112 is the value of a computation result of the computation table 504-1a in which the flow ID is “#2”. A computation result 702-121 is the value of a computation result of the computation table 504-1b in which the flow ID is “#1”. A computation result 702-122 is the value of a computation result of the computation table 504-1b in which the flow ID is “#2”. A computation result 702-211 is the value of a computation result of the computation table 504-2a in which the flow ID is “#1”. A computation result 702-212 is the value of a computation result of the computation table 504-2a in which the flow ID is “#2”. A computation result 702-221 is the value of a computation result of the computation table 504-2b in which the flow ID is “#1”. A computation result 702-222 is the value of a computation result of the computation table 504-2b in which the flow ID is “#2”.

In FIG. 14, a computation result 702-301 and a computation result 702-302 are respectively the value of a computation result of a virtual multi-port table in which the flow ID is “#1” and the value of a computation result of the virtual multi-port table in which the flow ID is “#2” when the computation tables 504 (504-1a, 504-1b, 504-2a, and 504-2b) constitute the virtual multi-port table in the first embodiment.

When two packets arrive at the input packet control unit 303 (T1311), the input packet control unit 303 in the first embodiment transmits RD requests to the input table updating unit 309. Here, an RD request about the first packet is transmitted to the access table searching module 501-1R, and an RD request about the second packet is transmitted to the access table searching module 501-2R.

At T1311, the access table searching module 501-1R and the access table searching module 501-2R each execute the RD access table searching processing S950 and obtain results of the search, which are each latest access destination information “0” (“0” indicates the computation table set 505-1). The access table selecting module 503 then executes the RD access table selecting processing S1150, and obtains a computation result A1 from the computation table 504-1a and a computation result A2 from the computation table 504-1b.

After the computation results are obtained, the input packet control unit 303 executes computation processing for the first packet and the second packet separately, and updates the computation result A1 to a computation result A1′ and the computation result A2 to a computation result A2′.

After updating the computation results, the input packet control unit 303 transmits WR requests to the input table updating unit 309. Here, a WR request about the first packet (including the computation result A1′) is transmitted to the access table searching module 501-1W, and a WR request about the second packet (including the computation result A2′) is transmitted to the access table searching module 501-2W.

The access table searching module 501-1W and the access table searching module 501-2W each execute the WR access table searching processing S1050 and, as a result of the search, obtain latest access destination information “0” (“0” indicates the computation table set 505-1). The access table selecting module 503 then executes the WR access table selecting processing 1250 to update the computation table 504-1a and the computation table 504-1b so that the computation result A1′ is written in the computation result field 702 in an entry that holds “#1” as the flow ID, and to update the computation table 504-2a and the computation table 504-2b so that the computation result A2′ is written in the computation result field 702 in an entry that holds “#2” as the flow ID.

The access table selecting module 503 further updates the latest access holding tables 502-1 and 502-2 so that the latest access destination information value is “1” (“1” indicates the computation table set 505-2) in an entry that holds “2” as the flow ID.

Through this processing, the computation result 702-301 and computation result 702-302 of the virtual multi-port table which are A1 and A2, respectively, at T1311 can be processed virtually so as to be seemingly updated to A1′ and A2′, respectively, at T1312.

As described above, the communication apparatus 3 according to the first embodiment configures a virtual multi-port table from a plurality of 1RD/1WR computation tables 504 (504-1a, 504-1b, 504-2a, and 504-2b) in the input table updating unit 309. The communication apparatus 3 uses the latest access holding tables 502 (502-1 and 502-2) to manage information of the computation table sets 505, which hold flow-by-flow latest computation results. The communication apparatus 3 can thus execute table updating processing even when two packets arrive every clk.

Therefore, according to the first embodiment, table updating processing of a computation function of the type of band control function is accomplished in high-speed packet processing that deals with the arrival of a plurality of packets in one clk, by configuring one virtual table and concurrently executing a plurality of RDs and a plurality of WRs in one clk, even when a single table is capable of processing only one RD and one WR in one clk.

### Second Embodiment

The communication apparatus 3 in the first embodiment configures one virtual 2RD/2WR table in the form of a virtual multi-port table to execute table updating processing in the case where two packets arrive every clk. A communication apparatus in a second embodiment of this invention is an expansion of the first embodiment, and configures one virtual 3RD/3WR table to execute table updating processing in the case where three packets arrive every clk. In the second embodiment, this invention is applied to a computation function of the type of band control function as in the first embodiment. A relation between the packet arrival interval and table updating processing timing in the second embodiment is outlined below.

<Packet Arrival Interval and Table Updating Processing Timing Example>

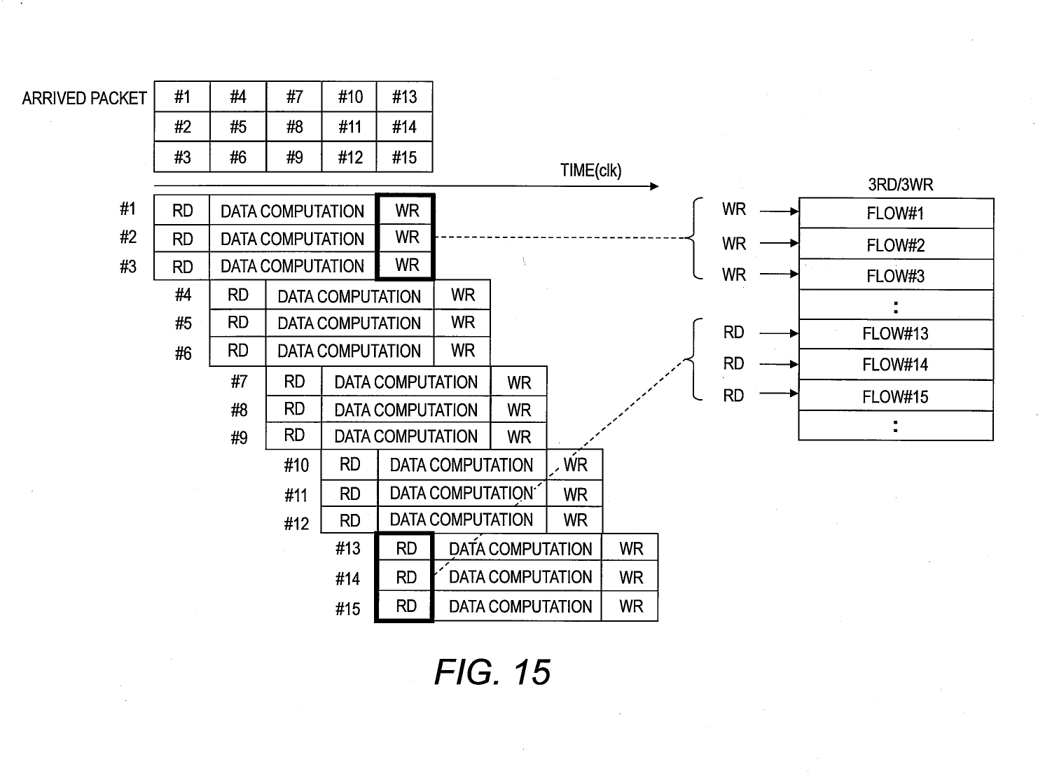

FIG. 15 is an explanatory diagram outlining the packet arrival interval and table updating processing timing in the second embodiment. For example, in the case where three packets arrive at the communication apparatus 3 in one clk, and the length of table updating time is five clks as in FIGS. 1A and 1B of the first embodiment, WRs due to the first packet arrival, the second packet arrival, and the third packet arrival coincide with RDs due to the thirteenth packet arrival, the fourteenth packet arrival, and the fifteenth packet arrival. A table in this case is required to process three RDs and three WRs concurrently (processing three RDs and three WRs at the same time is hereinafter referred to as 3RD/3WR) every clk. However, tables included in the communication apparatus are each a 1RD/1WR table, and cannot process three RDs and three WRs in one clk.

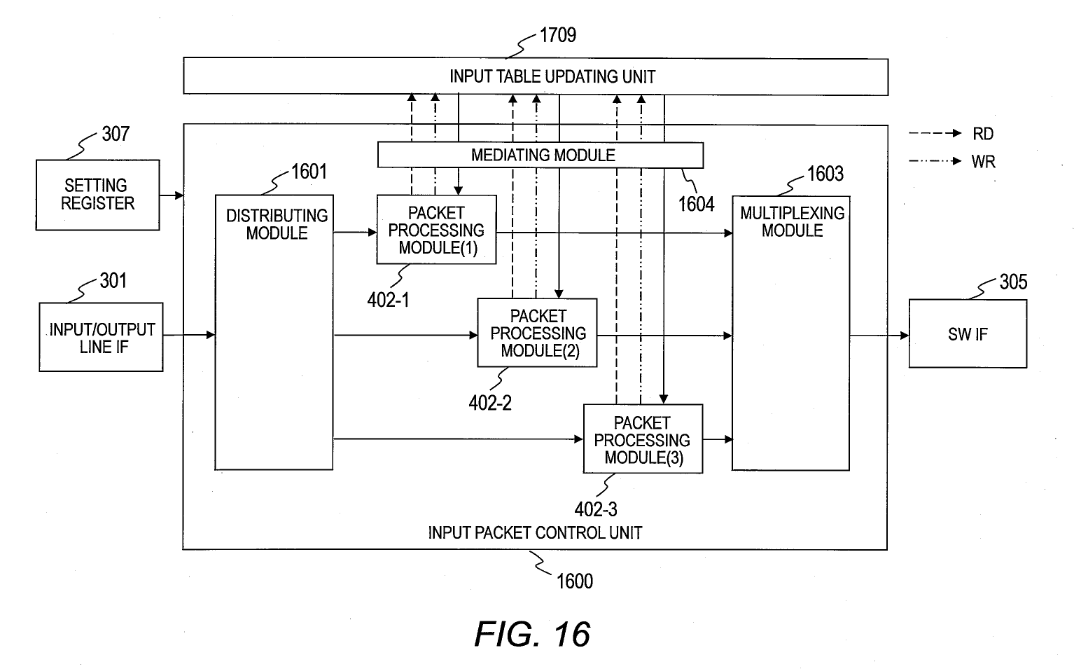

The communication apparatus 3 in the second embodiment therefore configures a virtual multi-port RAM (virtual multi-port table) described below to execute table updating processing in the case where three packets arrive every clk. The virtual multi-port table in the second embodiment includes a plurality of 1RD/1WR tables to implement one virtual 3RD/3WR table. The second embodiment is described below with reference to FIGS. 16 to 22.

<Configuration Example of an Input Packet Control Unit>

FIG. 16 is a block diagram illustrating the logical configuration of an input packet control unit according to the second embodiment. The input packet control unit, which is denoted by 1600, includes a distributing module 1601, three packet processing modules 402 (402-1 to 402-3), a multiplexing module 1603, and a mediating module 1604. The packet processing modules 402 in the second embodiment are the same as the packet processing modules 402 in the first embodiment.

When the input packet control unit 1600 receives an input packet from the input/output line interface 301, the distributing module 1601 determines one of the packet processing modules 402-1 to 402-3 as the packet processing module 402 that executes the packet processing, and distributes the packet to the determined packet processing module 402. The distributing module 1601 is the same as the distributing module 401 in the first embodiment, except the difference in the count of the packet processing modules among which packets are distributed.

The mediating module 1604 sorts RD requests and WR requests transferred from the packet processing modules 402 (402-1 to 402-3), and transfers the requests for the packet processing module 402-1, the requests for the packet processing module 402-2, and the requests for the packet processing module 402-3 separately to an input table updating unit 1709. In a similar fashion, the mediating module 1604 receives an RD result for the packet processing module 402-1, an RD result for the packet processing module 402-2, and an RD result for the packet processing module 402-3 separately from the input table updating unit 1709, and notifies the RD results to the packet processing modules 402 (402-1 to 402-3). The mediating module 1604 is the same as the mediating module 404 in the first embodiment, except the difference in the count of groups in which information is transferred to the packet processing modules 402 (402-1 to 402-3) or to the input table updating unit 1709.

The multiplexing module 1603 multiplexes packets received from the respective packet processing modules 402, and transmits the multiplexed packets to the SW interface 305 in the order of arrival of the packets. The input packet control unit 1600 in the second embodiment takes a predetermined time to finish packet processing.

The count of the packet processing modules 402 which is three in the second embodiment to match the speed of a line to which the communication apparatus 3 is coupled (the count of packets that arrive simultaneously) may instead be N as in the first embodiment. The mediating module 1604 in this case performs mediation in which N groups of RD requests and WR requests transferred from the packet processing modules 402 are sorted into three groups of RD requests and WR requests, and transfers the three groups of requests to the input table updating unit 1709.

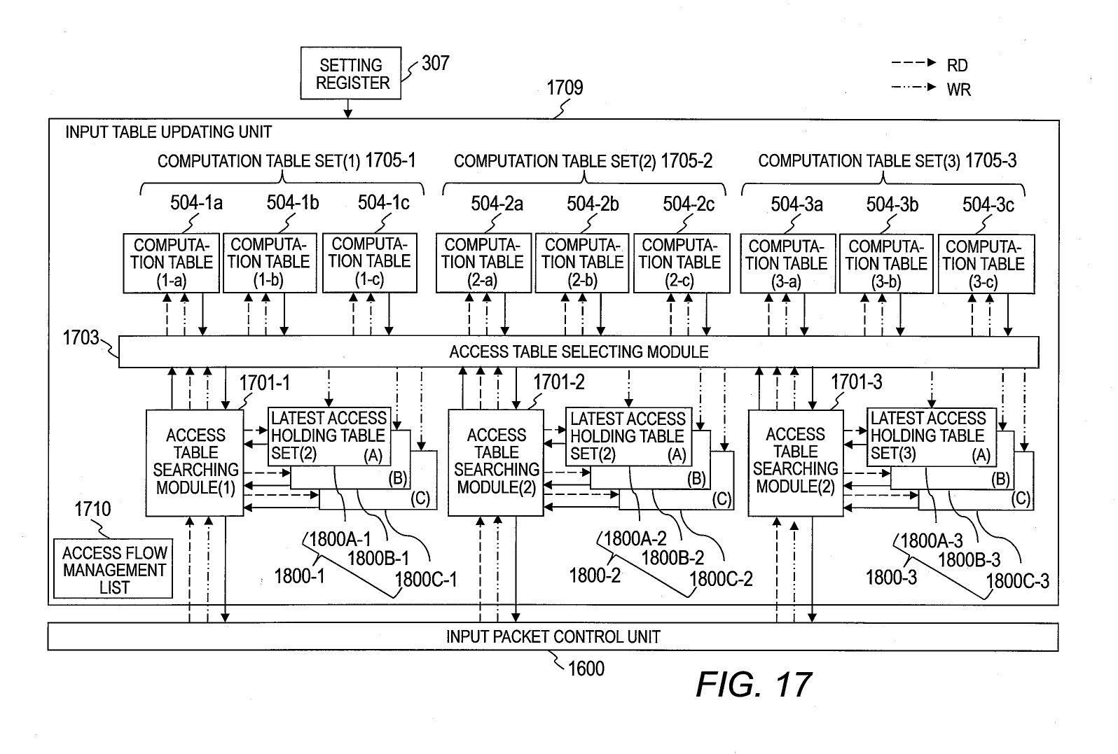

FIG. 17 is a block diagram illustrating the logical configuration of the input table updating unit 1709 of the second embodiment which is illustrated in FIG. 16. The input table updating unit 1709 includes access table searching modules 1701 (1701-1 to 1701-3), latest access holding table sets 1800 (1800-1 to 1800-3), an access table selecting module 1703, the computation tables 504 (504-1a to 504-1c, 504-2a to 504-2c, and 504-3a to 504-3c), and an access flow management list 1710.

The latest access holding table sets 1800-1, 1800-2, and 1800-3 include latest access holding tables 1800A-1 to 1800C-1, 1800A-2 to 1800C-2, and 1800A-3 to 1800C-3, respectively. “Computation table set 1705-1” is a collective term for the computation tables 504-1a to 504-1c. “Computation table set 1705-2” is a collective term for the computation tables 504-2a to 504-2c. “Computation table set 1705-3” is a collective term for the computation tables 504-3a to 504-3c.

In the second embodiment, those nine computation tables 504 (504-1a to 504-1c, 504-2a to 504-2c, and 504-3a to 504-3c) which are each a 1RD/1WR table constitute a virtual multi-port table, which implements one virtual 3RD/3WR computation table.

The access table searching modules 1701 (1701-1 to 1701-3) execute the same processing that is executed by the access table searching modules 501 in the first embodiment, except that tables referred to by the access table searching modules 1701 (1701-1 to 1701-3) are the latest access holding table sets 1800. The access table searching modules 1701 (1701-1 to 1701-3) refer to their respective associated latest access holding table sets 1800 (1800-1, 1800-2, and 1800-3), and notify latest access destination information which is described later to the access table selecting module 1703.

The access table searching modules 1701-1, 1701-2, and 1701-3 in the second embodiment each include a searching module for RD requests and a searching module for WR requests as in the first embodiment. In the description given here, however, the searching modules for RD requests and the searching modules for WR requests are collectively referred to as the access table searching modules 1701-1, 1701-2, and 1701-3 for the sake of convenience.

Similarly, the latest access holding table sets 1800-1, 1800-2, and 1800-3 each include a table set for RD requests and a table set for WR requests as in the first embodiment. In the description given here, however, the table sets for RD requests and the table sets for WR requests are collectively referred to as the latest access holding table sets 1800-1, 1800-2, and 1800-3 for the sake of convenience.

The access table selecting module 1703 is a processing module configured to receive RD request from the access table searching modules 1701 and then execute RD access table selecting processing S2050, which is described later, to read information out of the computation tables 504. The access table selecting module 1703 is also a processing module configured to receive WR requests from the access table searching modules 1701 and then execute WR access table selecting processing S2250, which is described later, to write information in the computation tables 504.

The access table selecting module 1703 uses latest access destination information that is received from one of the access table searching modules 1701 at the same time as an RD request or a WR request, to select the computation table 504 out of which data is to be read or the computation table 504 in which data is to be written. In the case where the computation table 504 (the computation table set 1705) to which a write is to be made is changed from a computation table set that is indicated by latest access destination information received at the same time as a WR request, the access table selecting module 1703 writes back the result of the change to all of the latest access holding table sets 1800-1 to 1800-3.

The access flow management list 1710 shows the WR address of an input packet for which the access table selecting module 1703 is executing the WR access table selecting processing S2250, the processing status of the access table selecting module 1703, and latest access destination information for continued processing.

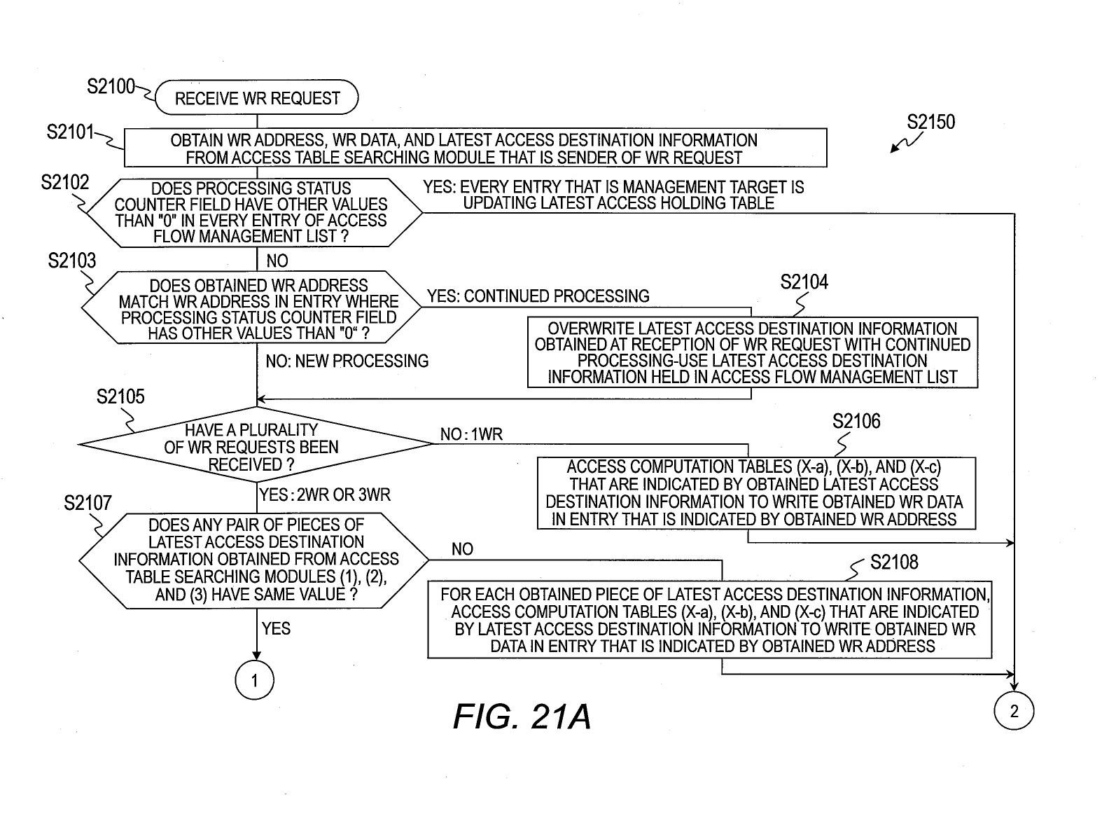

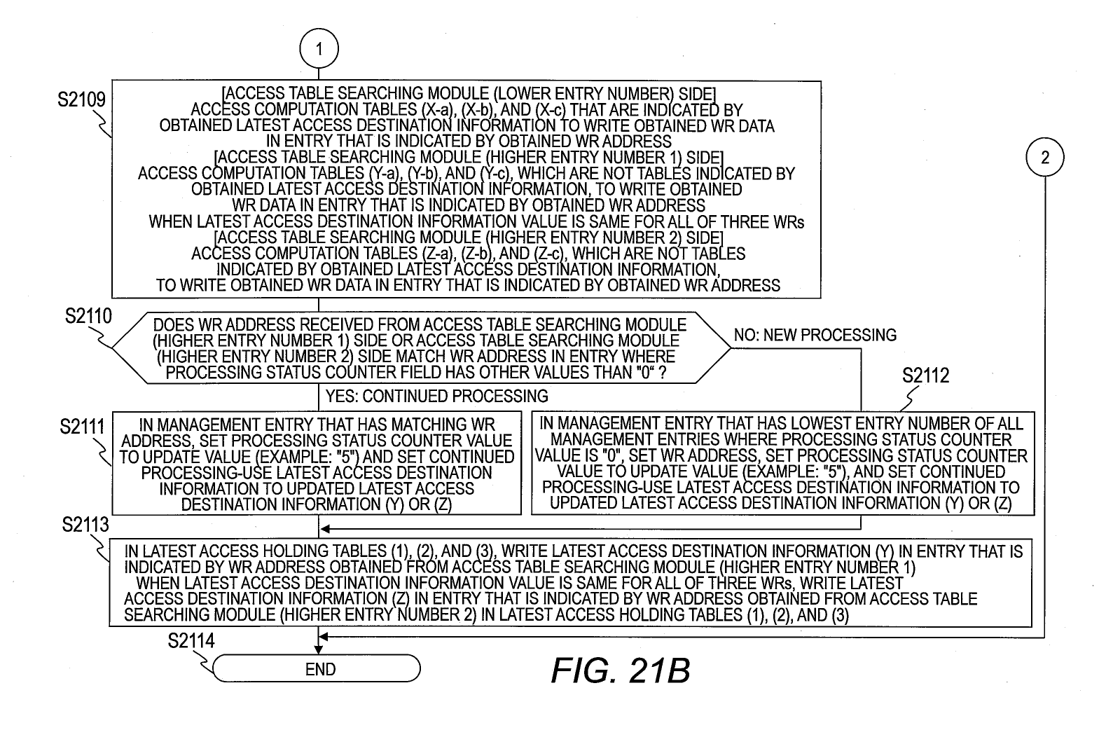

The input table updating module 1709 keeps the access flow management list 1710 in a memory that is included in the logical circuit 302, or in a similar place, and manages the access flow management list 1710 through the access flow management processing S1350, which is the same as in the first embodiment. The access table selecting module 1703 updates the access flow management list 1710 in WR access table selecting processing S2150, as illustrated in FIGS. 21A and 21B.

<Example of Information Stored in the Latest Access Holding Table Sets>

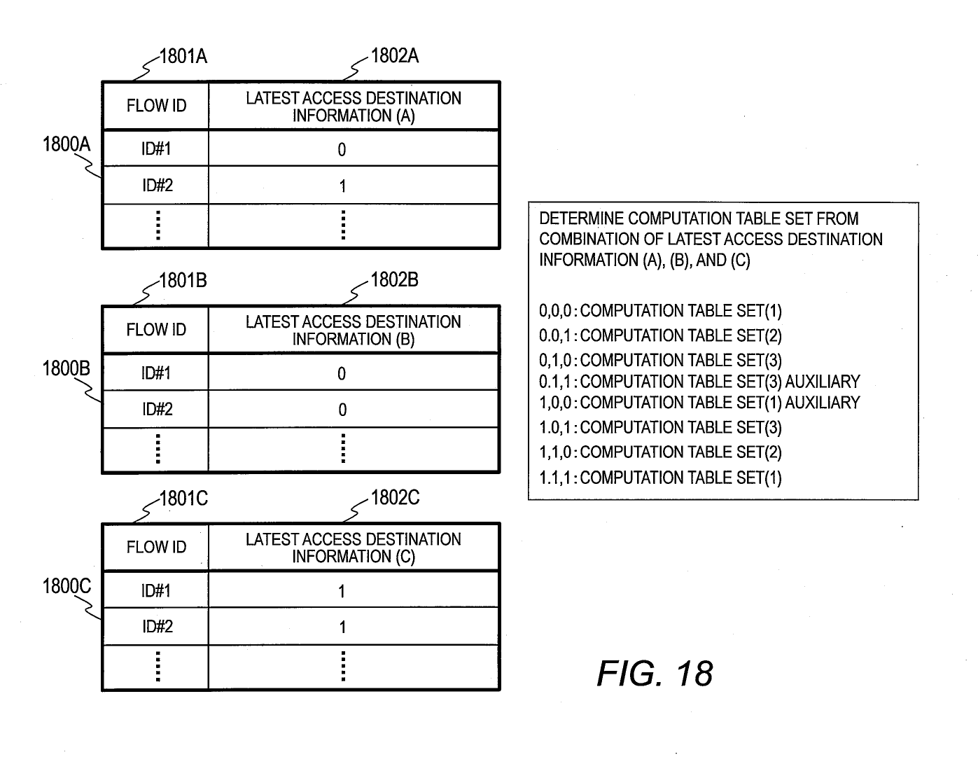

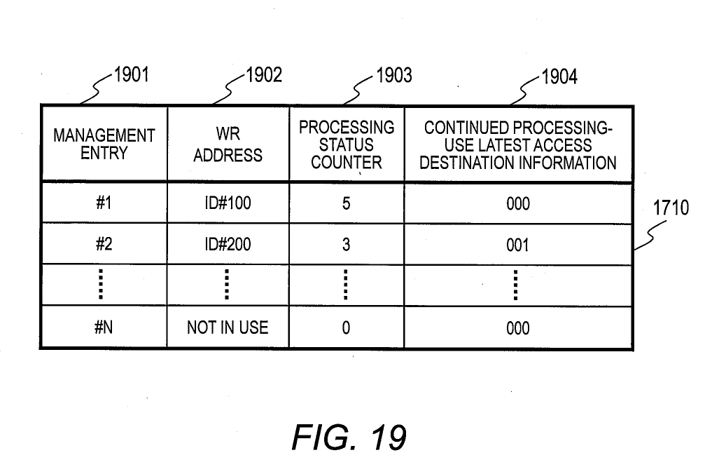

FIG. 18 is an explanatory diagram illustrating the latest access holding table sets of the second embodiment. The latest access holding table sets 1800-1, 1800-2, and 1800-3 are collectively referred to as latest access holding table sets 1800. The latest access holding tables 1800A-1, 1800A-2, and 1800A-3 are collectively referred to as latest access holding tables 1800A. The latest access holding tables 1800B-1, 1800B-2, and 1800B-3 are collectively referred to as latest access holding tables 1800B. The latest access holding tables 1800C-1, 1800C-2, and 1800C-3 are collectively referred to as latest access holding tables 1800C.

The latest access holding table sets 1800 are table sets holding information about which of the computation tables 504 (504-1a to 504-1c, 504-2a to 504-2c, and 504-3a to 504-3c) (here, managed as the computation table sets 1705) is a table where the latest flow-by-flow information is written with respect to a packet received by the communication apparatus 3. The latest access holding table sets 1800 include the latest access holding tables 1800A to 1800C.

The latest access holding tables 1800A to 1800C include flow ID field 1801A to 1801C, respectively, and latest access destination information fields 1802A to 1802C, respectively, to store the values of the fields 1801A to 1801C and the values of the fields 1802A to 1802C for each flow. The flow ID fields 1801A to 1801C each contain the flow ID of an input packet. The latest access destination information fields 1802A to 1802C each contain a value about a computation table set that holds flow-by-flow latest information of a computation result with respect to the packet.

In the second embodiment, which computation table set 1705 is to be accessed is determined by the combination of values in the latest access destination information fields 1802A to 1802C. For example, when the combination of values in the latest access destination information fields 1802A to 1802C, which is expressed as (A, B, C), is (0, 0, 0), the computation table set 1705-1 is indicated in the second embodiment. Combinations (0, 0, 1), (0, 1, 0), (0, 1, 1), (1, 0, 0), (1, 0, 1), (1, 1, 0), and (1, 1, 1) as the (A, B, C) combination indicate the computation table set 1705-2, the computation table set 1705-3, the computation table set 1705-3 (auxiliary), the computation table set 1705-1 (auxiliary), the computation table set 1705-3, the computation table set 1705-2, and the computation table set 1705-1, respectively. The latest access holding table sets 1800 are updated in Step S2113 of FIG. 21B.

<Example of Information Stored in the Access Flow Management List 1710>

FIG. 19 is an explanatory diagram illustrating the access flow management list 1710 of the second embodiment. The access flow management list 1710 includes a management entry field 1901, a WR address field 1902, a processing status counter field 1903, and a continued processing-use latest access destination information field 1904, and stores the values of the respective fields 1901 to 1904 for each management entry. The management entry field 1901 is the same as the management entry field 801 in the first embodiment, except for the count of entries. The WR address field 1902 is the same as the WR address field 802 in the first embodiment.

The processing status counter field 1903 is the same as the processing status counter field 803 in the first embodiment, except the difference in time required to write data in tables (the tables in question in the first embodiment are the latest access holding tables 502, and the tables in question in the second embodiment are the latest access holding table sets 1800), if there is any.

The continued processing-use latest access destination information field 1904 stores latest access destination information for continuing processing that has not been finished. The continued processing-use latest access destination information field 1904 stores a value about the computation table set 1705 that is to be maintained as access destination so that processing a WR request can be continued even when another WR request that has the same WR address as the current WR request arrives before the access table selecting module 1703 finishes processing of writing in the latest access holding table sets 1800 in the WR access table selecting processing S2150 described later.

The following is a description on RD access table selecting processing S2050, which is executed by the access table selecting module 1703 of the second embodiment.

<RD Access Table Selecting Processing S2050>

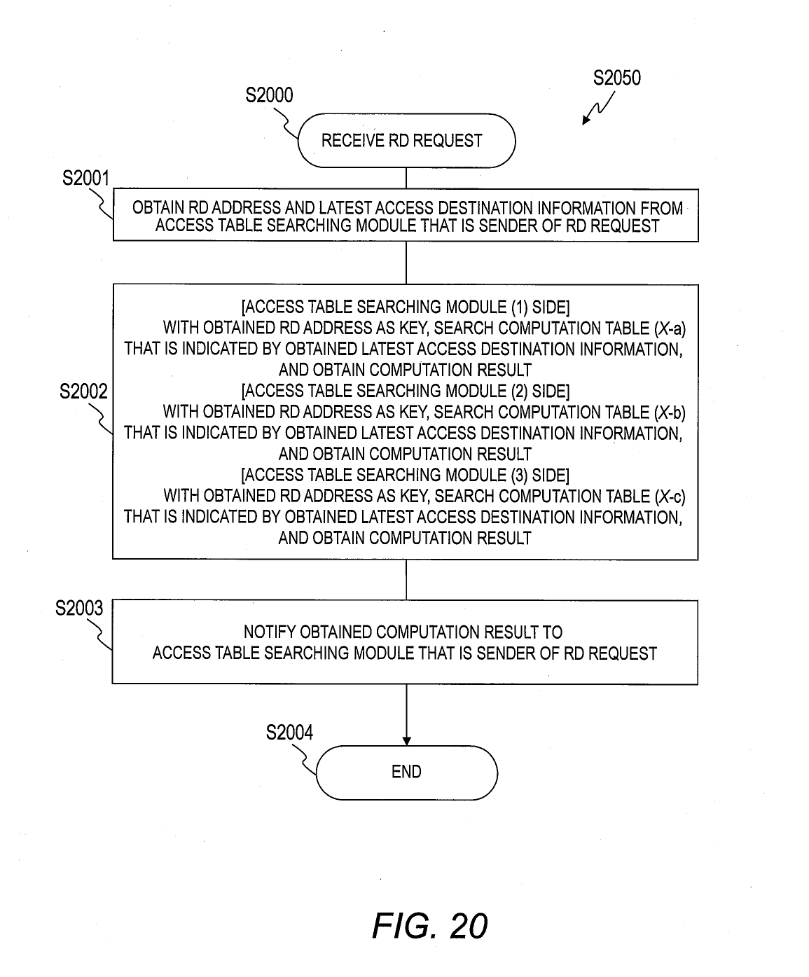

FIG. 20 is a flow chart illustrating the RD access table selecting processing S2050, which is executed by the access table selecting module 1703 of the second embodiment. When receiving an RD request from at least one of the access table searching modules 1701 (1701-1 to 1701-3) (the respective RD requests may be received simultaneously from the access table searching module 1701-1, the access table searching module 1701-2, and the access table searching module 1701-3) (S2000), the access table selecting module 1703 obtains an RD address and latest access destination information that are received at the same time as the RD request from the access table searching module 1701 (S2001).

After Step S2001, the access table selecting module 1703 uses the RD address obtained in Step S2001 as a key to search the computation table 504 (one of 504-1a to 504-1c, 504-2a to 504-2c, and 504-3a to 504-3c) that is indicated by the latest access destination information obtained in Step S2001, and obtains a computation result (S2002). In the case where the RD request obtained in Step S2000 is from the access table searching module 1701-1, the access table selecting module 1703 in the second embodiment accesses the computation table set 1705-X (symbol X represents 1, 2, or 3, and indicates any one of the computation table sets 1705-1 to 1705-3) that is indicated by the latest access destination information obtained in Step S2001, and searches the set's a-side computation table (X-a) 504-Xa.

In the case where the RD request obtained in Step S2000 is from the access table searching module 1701-2, the access table selecting module 1703 accesses the computation table set 1705-X that is indicated by the latest access destination information obtained in Step S2001, and searches the set's b-side computation table (X-b) 504-Xb. In the case where the RD request obtained in Step S2000 is from the access table searching module 1701-3, the access table selecting module 1703 accesses the computation table set 1705-X that is indicated by the latest access destination information obtained in Step S2001, and searches the set's c-side computation table (X-c) 504-Xc.

In Step S2002, the access table selecting module 1703 searches separate computation tables 504 to process RD requests that are received simultaneously from the access table searching module 1701-1 to the access table searching module 1701-3. The virtual multi-port table of the second embodiment which constitutes one virtual 3RD/3WR computation table can thus process three RD requests concurrently.

In the second embodiment, RD requests of the access table searching module 1701-1 are associated with the computation table 504-Xa, RD requests of the access table searching module 1701-2 are associated with the computation table 504-Xb, and RD requests of the access table searching module 1701-3 are associated with the computation table 504-Xc. However, any of the access table searching modules 1701 can be associated with any the computation tables 504.

The access table selecting module 1703 in the second embodiment can search any one of the computation table 504-Xa, the computation table 504-Xb, and the computation table 504-Xc to process an RD request in the case where RD requests are not received simultaneously from the access table searching module 1701-1 to the access table searching module 1701-3 (i.e., in the case where only one RD request is received), or in the case where RD requests are received simultaneously from the access table searching module 1701-1 to the access table searching module 1701-3 but different computation table sets 1705-X are indicated by the obtained pieces of latest access destination information.

After Step S2002, the access table selecting module 1703 notifies the computation result obtained in Step S2002 to the access table searching module 1701 that is the sender of the RD request (S2003), and ends the RD access table selecting processing S2050 illustrated in FIG. 20 (S2004). The access table searching module 1701 notifies the computation result notified in Step S2003 to the input packet control unit 1600 as RD data, to thereby complete RD to the relevant computation table 504 in the input packet control unit 1600.

Given below with reference to FIGS. 21A and 21B is a description on WR access table selecting processing S2150, which is executed by the access table selecting module 1703 of the second embodiment.

<WR Access Table Selecting Processing S2150>

FIG. 21A is a flow chart (first half) illustrating a detailed processing procedure example of the WR access table selecting processing S2150, which is executed by the access table selecting module 1703 of the second embodiment. FIG. 21A illustrates, of the WR access table selecting processing S2150, which is executed by the access table selecting module 1703 of the second embodiment, processing for the case where one WR request is received, and processing for the case where two or three WR requests are received and pieces of latest access destination information associated with the two or three WR requests are different from each other.

When receiving a WR request from at least one of the access table searching modules 1701 (1701-1 to 1701-3) (the respective WR requests may be received simultaneously from the access table searching module 1701-1 to the access table searching module 1701-3) (S2100), the access table selecting module 1703 obtains a WR address, WR data, and latest access destination information that are received at the same time as the WR request from the access table searching module 1701 (S2101).

After Step S2101, the access table selecting module 1703 determines whether or not the processing status counter has other values than “0” for every management entry registered in the access flow management list 1710 (S2102).

When it is determined in Step S2102 that the processing status counter value is other than “0” for every management entry 2001 in the access flow management list 1710 (Step S2102: Yes), the access table selecting module 1703 proceeds to processing of FIG. 21B and ends the WR access table selecting processing S2150 illustrated in FIGS. 21A and 21B (S2114).

When it is found in Step S2102 that management entries of the access flow management list 1710 include at least one management entry whose processing status counter value is “0” (Step S2102: No), the access table selecting module 1703 proceeds to Step S2103.

In the case where WR requests have been received simultaneously from the access table searching module 1701-1 to the access table searching module 1701-3 in Step S2100, the access table selecting module 1703 checks in Step S2102 whether a management entry is capable of processing of a plurality of entries (two or three entries). In the case where a management entry whose processing status counter value is “0” out of the management entries of the access flow management list 1710 is capable of processing of the plurality of entries received in Step S2100, the access table selecting module 1703 proceeds to Step S2103.

In the case where the management entry whose processing status counter value is “0” is not capable of processing of the plurality of entries received in Step S2100, the access table selecting module 1703 proceeds to the processing of FIG. 21B and ends the WR access table selecting processing S2150 illustrated in FIGS. 21A and 21B. Alternatively, in the case where the management entry whose processing status counter value is “0” is not capable of processing of the plurality of entries received in Step S2100, the access table selecting module 1703 may proceed to Step S2103 to process a WR request for the management entry whose processing status counter value is “0”, and proceed to the processing of FIG. 21B to process the rest of WR requests and end the WR access table selecting processing S2150 illustrated in FIGS. 21A and 21B.

In Step S2103, the access table selecting module 1703 determines whether or not the value of the WR address obtained in Step S2101 matches the value of the WR address in a management entry whose processing status counter value is other than “0” (S2103). When it is determined in Step S2103 that the value of the WR address obtained in Step S2101 does not match the value of the WR address in a management entry 2001 that holds other values than “0” in the processing status counter 2003 (S2103: No), the access table selecting module 1703 uses the latest access destination information obtained in Step S2101 and proceeds to Step S2105.

When it is determined in Step S2103 that the value of the WR address obtained in Step S2101 matches the value of the WR address in a management entry whose processing status counter value is other than “0” (S2103: Yes), on the other hand, the access table selecting module 1703 overwrites the latest access destination information obtained in Step S2101 with the value of the continued processing-use latest access destination information field 2004 in the management entry whose WR address matches the obtained WR address, and keeps the updated information (S2104). The access table selecting module 1703 then proceeds to Step S2105.

The access table selecting module 1703 then determines whether or not a plurality of WR requests have been received in Step S2100 (S2105). When it is determined in Step S2105 that the number of WR requests received in Step S2100 is not more than one (Step S2105: No), one WR request has been received in Step S2100 by the access table selecting module 1703. The access table selecting module 1703 therefore accesses the a-side to c-side computation tables 504 (504-Xa to 504-Xc) of the computation table set 1705-X that is indicated by the latest access destination information obtained in Step S2101, or by the latest access destination information written in Step S2104 as an overwrite, to write the obtained WR data in an entry that is indicated by the WR address obtained in Step S2101 (S2106). The symbol X represents 1, 2, or 3, and indicates one of the computation table sets 1705-1 to 1705-3.

In the second embodiment, the access table selecting module 1703 updates the a-side, b-side, and c-side computation tables 504 (504-Xa to 504-Xc) that are included in one computation table set 1705 with the same WR data, thereby synchronizing information between tables in the same computation table set 1705. With the computation tables 504 of the computation table set 1705 synchronized with each other in Step S2002 of the RD access table selecting processing S2050 described above, this ensures that searching any one of the a-side computation table 504, the b-side computation table 504, or the c-side computation table 504 yields the same information.

After Step S2106, the access table selecting module 1703 proceeds to the processing of FIG. 21B and ends the WR access table selecting processing S2150 illustrated in FIGS. 21A and 21B (S2114).

In the case where it is determined in Step S2105 that a plurality of WR requests have been received in Step S2100 (Step S2105: Yes), on the other hand, the number of WR requests received in S2100 by the access table selecting module 1703 is two or three. Then, the access table selecting module 1703 determines whether or not, of the pieces of latest access destination information that are associated with WR requests received from the access table searching modules 1701 (1701-1 to 1701-3) (the information obtained in Step S2101 or written in Step S2104 as an overwrite), at least one pair of pieces of latest access destination information has the same value (S2107).

When it is determined in Step S2107 that no pair of pieces of latest access destination information has the same value (Step S2107: No), it means that different computation table sets 1705 are to be updated to process the plurality of received WR requests. Accordingly, for each piece of latest access destination information obtained, the access table selecting module 1703 accesses the a-side to c-side computation tables 504 (504-Xa to 504-Xc) of the computation table set 1705-X that is indicated by the latest access destination information to write the obtained WR data in an entry that is indicated by the WR address obtained in Step S2101 (S2108).

After Step S2108, the access table selecting module 1703 proceeds to the processing of FIG. 21B and ends the WR access table selecting processing S2150 illustrated in FIGS. 21A and 21B (S2114).

When it is determined in Step S2107 that at least one pair of pieces of latest access destination information has the same value (Step S2107: Yes), on the other hand, it means that the same computation table set 1705 is to be updated to process two or three WR requests. Accordingly, the access table selecting module 1703 proceeds to Step S2109 of FIG. 21B, where, in order to avoid contention, different computation table sets are selected as the computation table sets 1705 to be updated to process the two or three WR requests.

FIG. 21B is a flow chart (second half) illustrating a detailed processing procedure example of the WR access table selecting processing S2150, which is executed by the access table selecting module 1703 of the second embodiment. FIG. 21B illustrates, in the WR access table selecting processing S2150, which is executed by the access table selecting module 1703 of the second embodiment, processing for the case where two or three WR requests are received and pieces of latest access destination information associated with the two or three WR requests are the same.

In Step S2109, of the WR requests that are associated with the at least one pair of pieces of latest access destination information that have the same value, the access table selecting module 1703 processes the WR request received from the access table searching module 1701 that has the lowest number by accessing the a-side to c-side computation tables 504 (504-Xa to 504-Xc) of the computation table set 1705-X that is indicated by the latest access destination information to write the obtained WR data in an entry that is indicated by the WR address obtained in Step S2101.

Further, of the WR requests that are associated with the at least one pair of pieces of latest access destination information that have the same value, the access table selecting module 1703 processes the WR request received from the access table searching module 1701 that has the highest number (higher number 1) by accessing the a-side to c-side computation tables 504 (504-Ya to 504-Yc) of the computation table set 1705-Y, which is different from the computation table set 1705-X indicated by the latest access destination information, to write the obtained WR data in an entry that is indicated by the WR address obtained in Step S2101. The symbol Y represents 1, 2, or 3, and indicates one of the computation table set 1705-1 to the computation table set 1705-3. The value of Y differs from the value of X.

In the case where the access table selecting module 1703 has received three WR requests and two of the three WR requests are associated with a pair of pieces of latest access destination information that have the same value, the access table selecting module 1703 determines the value of Y so as to avoid contention between the latest access destination information value of the WR request that is not associated with the pair and the value of Y.

Further, in the case where the access table selecting module 1703 has received three WR requests and all the three WR requests are associated with a pair of pieces of latest access destination information that have the same value, of the WR requests that are associated with the at least one pair of pieces of latest access destination information that have the same value, the access table selecting module 1703 processes the WR request received from the access table searching module 1701 that has the highest number (higher number 2) by accessing the a-side to c-side computation tables 504 (504-Za to 504-Zc) of the computation table set 1705-Y, which is different from the computation table set 1705-X indicated by the latest access destination information, to write the obtained WR data in an entry that is indicated by the WR address obtained in Step S2101 (S2109). The symbol Z represents 1, 2, or 3, and indicates one of the computation table set 1705-1 to the computation table set 1705-3. The value of Z differs from the values of X and Y.

The access table selecting module 1703 processes in Step S2109 WR requests that are received simultaneously from the access table searching module 1701-1 to the access table searching module 1701-3 by respectively updating the computation tables 504 that are included in separate computation table sets 1705. For each of the WR requests, WR data of the WR request can thus be held in one computation table set 1705. This enables the virtual multi-port table of the second embodiment which constitutes one virtual 3RD/3WR computation table to process three WR requests concurrently.

After Step S1209, the access table selecting module 1703 determines whether or not the WR address received from the access table searching module 1701 that has the higher number 1 or the higher number 2 matches the WR address value in a management entry where the processing status counter value is other than “0” (S2110).

When it is determined in Step S2110 that the received WR address matches (Step S2110: Yes), the access table selecting module 1703 updates the processing status counter value of the management entry that has the matching WR address with a value that indicates the write time. The access table selecting module 1703 also updates the value of the continued processing-use latest access destination information of the management entry that has the matching WR address with the value of Y or Z selected in Step S2109 (S2111). After Step S2111, the access table selecting module 1703 proceeds to Step S2113.

In the case where it is determined in Step S2110 that the received WR address does not match (Step S2110: No), on the other hand, the access table selecting module 1703 extracts an entry that has the lowest entry number (the smallest entry number) of management entries on the access flow management list 1710 that have “0” as the processing status counter value. The access table selecting module 1703 determines the extracted management entry as an internal logical circuit that newly executes processing related to the WR request.

The access table selecting module 1703 then updates the WR address of the extracted management entry with the value of the WR address obtained from the access table searching module 1701 in question in Step S1201. The access table selecting module 1703 updates the processing status counter value of the extracted management entry with a value that indicates the write time. The access table selecting module 1703 updates the value of the continued processing-use latest access destination information of the extracted management entry with the value of Y or Z selected in Step S2109 (S2112).

After Step S2112, the access table selecting module 1703 proceeds to Step S2113. In Step S2113, the access table selecting module 1703 accesses the latest access holding table sets 1800-1 to 1800-3 to write the value of Y selected in Step S2109 in an entry (flow ID) that is indicated by the value of the WR address obtained in Step S2101 from the access table searching module 1701 that has the higher number 1.

In the case where three WR requests are associated with the at least one pair of pieces of latest access destination information that have the same value, the access table selecting module 1703 also accesses the latest access holding table sets 1800-1 to 1800-3 to write the value of Z selected in Step S2109 in an entry (flow ID) that is indicated by the value of the WR address obtained in Step S2101 from the access table searching module 1701 that has the higher number 2.

This enables the access table selecting module 1703 to notify a change in latest access destination information to the access table searching modules 1701 (1701-1 to 1701-3), and enables the access table searching modules 1701 to process a subsequently received RD request or WR request by obtaining the changed information.

After Step S2113, the access table selecting module 1703 ends the WR access table selecting processing S2150 illustrated in FIGS. 21A and 21B (S2114). The latest access destination information changing processing (S2113) in the WR access table selecting processing S2150, which is executed by the access table selecting module 1703, is now described.

In Step S2113 of FIG. 21B, the values of two entries in the latest access holding table sets 1800-1 to 1800-3 are updated in some cases. The latest access holding table sets 1800 include, as illustrated in FIG. 18, the latest access holding tables 1800A to 1800C, which are each a 1RD/1WR table. Therefore, to update the value of one entry, one of the latest access holding tables 1800A to 1800C is updated in the second embodiment.

<Example of Latest Access Destination Information Changing Processing in the WR Access Table Selecting Processing S2150>

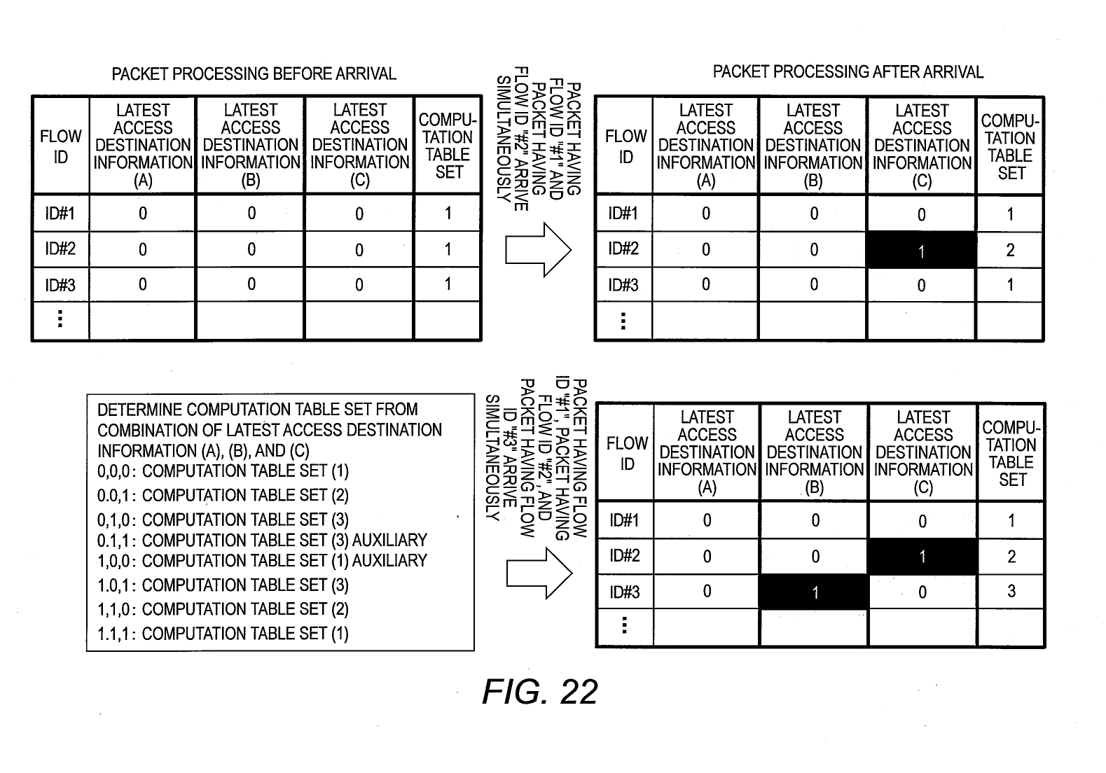

FIG. 22 is an explanatory diagram illustrating an example of latest access destination information changing processing in the WR access table selecting processing S2150, which is executed by the access table selecting module 1703, of the second embodiment. In the example of FIG. 22, latest access destination information of a flow of every packet arrived indicates a table set (1), and the latest access destination information of each flow is then updated.

Specifically, the premise of FIG. 22 is that (A, B, C), which represents the combination of latest access destination information 1902A of a flow having a flow ID “#1”, latest access destination information 1902B of a flow having a flow ID “#2”, and latest access destination information 1902C of a flow having a flow ID “#3”, is initially (0, 0, 0), which indicates the computation table set (1). FIG. 22 illustrates an example of updating those pieces of latest access destination information in the case where two packets that respectively have the flow ID “#1” and the flow ID “#2” arrive at the same time, and an example of updating those pieces of latest access destination information in the case where three packets that respectively have the flow ID “#1”, the flow ID “#2”, and the flow ID “#3” arrive at the same time.

In the case where two packets that respectively have the flow ID “#1” and the flow ID “#2” arrive at the same time, the access table selecting module 1703 changes, for example, the value of the latest access destination information held in an entry of the latest access holding table 1800C where the flow ID is “#2” from “0” to “1”, thereby changing the combination of the latest access destination information 1902A to the latest access destination information 1902C, (A, B, C), to (0, 0, 1), which indicates the computation table set (2). In the case where three packets that respectively have the flow ID “#1”, the flow ID “#2”, and the flow ID “#3” arrive at the same time, the access table selecting module 1703 changes, for example, the value of the latest access destination information held in an entry of the latest access holding table 1800B where the flow ID is “#3” from “0” to “1”, thereby changing the combination of the latest access destination information 1902A to the latest access destination information 1902C, (A, B, C), to (0, 1, 0), which indicates the computation table set (3).

The second embodiment thus accomplishes a change to latest access destination information as a measure to process a plurality of packets concurrently by changing one of the latest access holding tables 1800A to 1800C when latest access destination information of one entry is to be updated.

As described above, the communication apparatus 3 according to the second embodiment configures a virtual multi-port table from a plurality of 1RD/1WR computation tables 504 (504-1a to 504-1c, 504-2a to 504-2c, and 504-3a to 504-3c) in the input table updating unit 1709, and uses the latest access holding table sets 1800 (1800-1 to 1800-3) to manage information of the computation table sets 1705, which hold flow-by-flow latest computation results. The communication apparatus 3 of the second embodiment can thus execute table updating processing even when three packets arrive every clk.

While the second embodiment discusses the case where three packets arrive every clk, the communication apparatus 3 is also capable of executing table updating processing when, for example, K (K is an arbitrary natural number) packets arrive every clk by providing K computation table sets 1705 and configuring the latest access holding table sets 1800 that deal with changes to (K−1) pieces of latest access destination information in the input table updating unit 1709.

Therefore, according to the second embodiment, similarly to the first embodiment, table updating processing of a computation function of the type of band control function is accomplished in high-speed packet processing that deals with the arrival of a plurality of packets in one clk, by configuring one virtual table and concurrently executing a plurality of RDs and a plurality of WRs in one clk, even when a single table is capable of processing only one RD and one WR in one clk.

### Third Embodiment

The communication apparatus 3 in the first embodiment configures one virtual 2RD/2WR table in the form of a virtual multi-port table to execute table updating processing in the case where two packets arrive every clk. While this invention is applied to a computation function of the type of band control function in the first embodiment, a virtual multi-port table is applied to a computation function of the type of statistics counting function in a third embodiment of this invention.

In the third embodiment, how many packets are received and how many bytes are received are counted as statistics information of the statistics counting function. The statistics counting function includes, in addition to table updating processing that is executed to process an arrived packet, an RD for allowing the NIF management unit 308 (CPU) to obtain statistics information. A communication apparatus in the third embodiment configures one virtual 3RD/2WR table, and executes table updating processing in the case where two packets arrive every clk.

A relation between the packet arrival interval and table updating processing timing in the third embodiment is outlined below.

<Packet Arrival Interval and Table Updating Processing Timing Example>

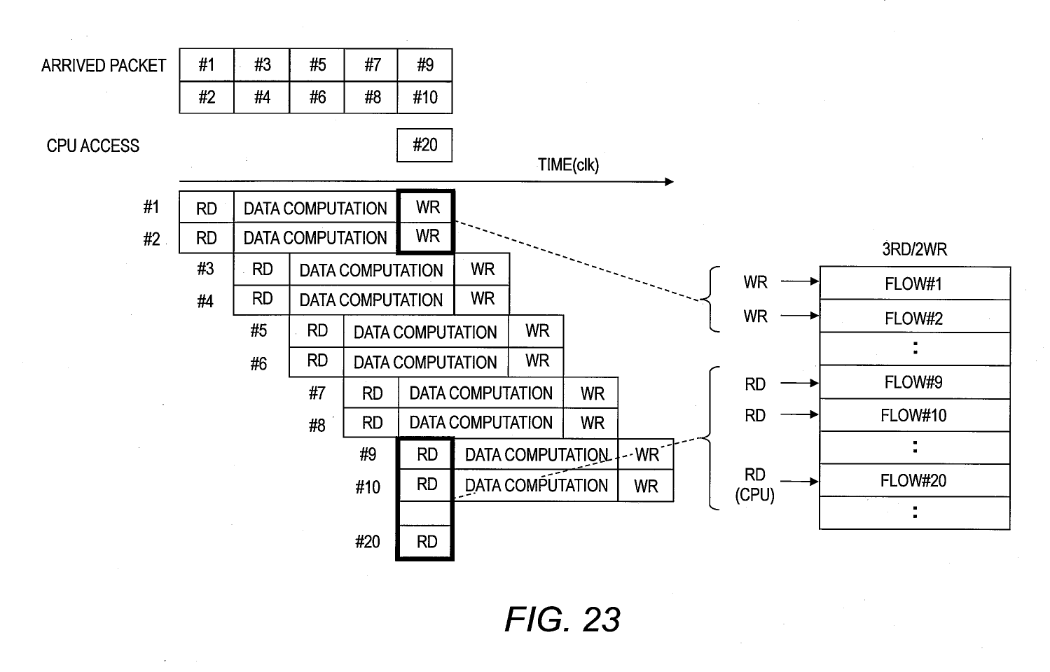

FIG. 23 is an explanatory diagram outlining the packet arrival interval and table updating processing timing in the third embodiment. For example, in the case where two packets arrive at the communication apparatus every clk, and the length of table updating time is five clks as in FIGS. 1A and 1B and FIG. 15, WRs due to the first packet arrival and the second packet arrival coincide with RDs due to the ninth packet arrival, and the tenth packet arrival.

In the case where an RD of statistics information by the CPU further coincides with those WRs and RDs, a table is required to process three RDs and two WRs concurrently in one clk (processing three RDs and two WRs at the same time is hereinafter referred to as 3RD/2WR). However, tables included in the communication apparatus are each a 1RD/1WR table, and cannot process three RDs and two WRs concurrently in one clk.

The communication apparatus in the third embodiment therefore configures a virtual multi-port RAM (virtual multi-port table) described below to execute table updating processing in the case where two packets arrive every clk and an RD of statistics information by the CPU is additionally executed. The virtual multi-port table in the third embodiment includes a plurality of 1RD/1WR tables to implement one virtual 3RD/2WR table.

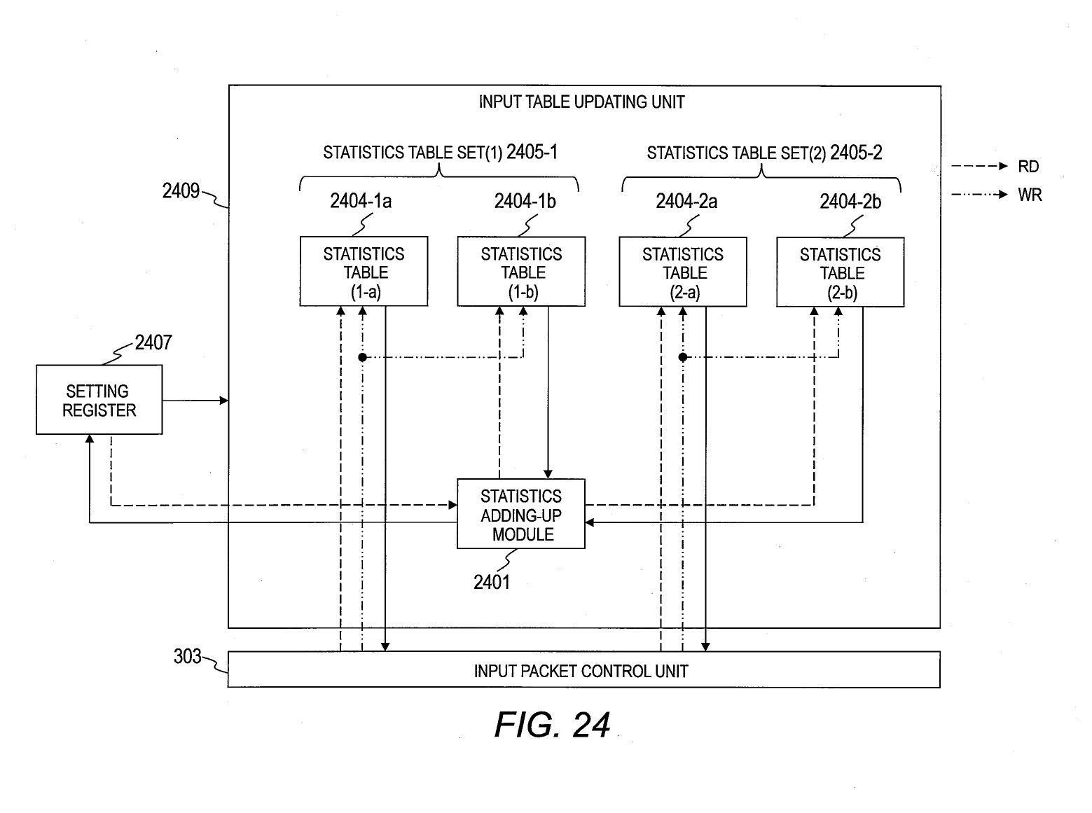

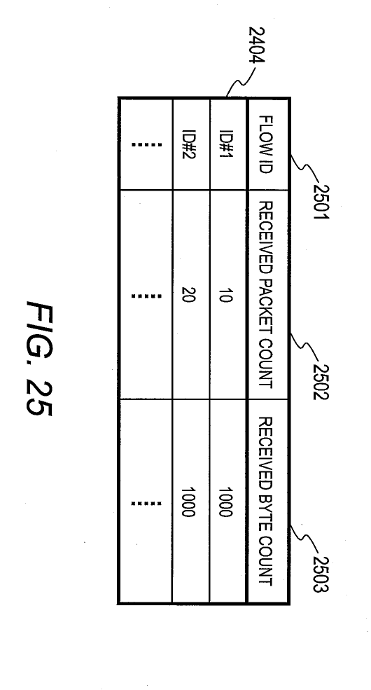

An input packet control unit in the third embodiment differs from the ones in the first embodiment and the second embodiment only in that the input packet control unit updates information by executing counting processing instead of the computation processing of the preceding embodiments. An input table updating unit of the communication apparatus in the third embodiment includes a module for adding up statistics in order to notify statistics information to the CPU. On the other hand, the input table updating unit does not include the access table searching modules 501, the latest access holding tables 502, the access table selecting module 503, and the access flow management list 510 unlike the input table updating units in the first embodiment and the second embodiment, because the statistics counting function merely requires counting the received packet count and the received byte count each time a packet arrives, and adding up the counts for notification to the CPU. The third embodiment is described below with reference to FIGS. 24 to 26.

<Configuration Example of the Input Table Updating Unit>

FIG. 24 is a block diagram illustrating the logical configuration of the input table updating unit of the third embodiment, which is denoted by 2409. The input table updating unit 2409 includes a statistics adding-up module 2401 and statistics tables 2404 (2404-1a, 2404-1b, 2404-2a, and 2404-2b). “Statistics table set 2405-1” is a collective term for the statistics tables 2404-1a and 2404-1b. “Statistics table set 2405-2” is a collective term for the statistics tables 2404-2a and 2404-2b.

In the third embodiment, those four computation tables 2404 (2404-1a, 2404-1b, 2404-2a, and 2404-2b) which are each a 1RD/1WR table constitute a virtual multi-port table, which implements one virtual 3RD/2WR computation table.

The input table updating unit 2409 in the third embodiment has one statistics table set 2405 (2405-1 or 2405-2) for each of two RD requests, or each of two WR requests, received from the input packet control unit 303. When receiving an RD request from the input packet control unit 303, the input table updating unit 2409 refers to the statistics table 2404-Xa of the statistics table set 2405-X that is associated with the received RD request to obtain statistics information. The symbol X represents 1 or 2, and indicates the statistics table set 2405-1 or 2405-2.

When receiving a WR request from the input packet control unit 303, the input table updating unit 2409 writes WR data in the statistics table 2404-Xa and statistics table 2404-Xb of the statistics table set 2405-X that is associated with the received WR request to update statistics information. In this manner, information of the statistics tables 2404 that are included in the same statistics table set 2405 is synchronized.

The input table updating unit 2409 in the third embodiment is connected to a setting register 2407. The NIF management unit 308 controls the setting register 2407 to obtain statistics information. The statistics adding-up module 2401 is a processing module for receiving an RD request from the setting register 2407 and then executes statistics notifying processing S2450, which is described later. The statistics adding-up module 2401 refers to the relevant statistics table 2404 and notifies statistics information to the setting register 2407.

This enables the communication apparatus to process two RD requests from the input packet control unit 303, one RD request from the setting register 2407, and two WR requests from the input packet control unit 303 that are all input in the same clock cycle (3RD/2WR processing).

<Example of Information Stored in the Statistics Tables>

FIG. 25 is an explanatory diagram illustrating the statistics tables 2404 of the third embodiment. The statistics tables 2404 are tables that hold information about packets received by the communication apparatus 3. The statistics tables 2404 each include a flow ID field 2501, a received packet count field 2502, and a received byte count field 2503, and store the values of the respective fields 2501 to 2503 for each flow.

The flow ID field 2501 contains the flow ID of an input packet. The received packet count field 2502 contains the number of input packets received by the input packet control unit 303 that have the same flow ID. The received byte count field 2503 indicates the total byte count of input packets received by the input packet control unit 303 that have the same flow ID. Specifically, the received packet count field 2502 and the received byte count field 2503 in each statistics table set 2405 hold information of only packets for which table updating is requested of the statistics table set 2405. In each statistics table set 2405, the received packet counts of all entries each holding information about packets of the same flow ID are added up, and received byte counts of all entries are also added up. The received packet counts of all statistics table sets 2405 and the received byte counts of all statistics table sets 2405 are then respectively added up, thereby obtaining the total number of all input packets received by the input packet control unit 303 and the total byte count of the input packets.

The statistics table set 2405-1 and the statistics table set 2405-2 handle different flows. Tables in the same statistics table set are synchronized with each other through write processing, and accordingly store the same information of the same flow. Specifically, the statistics table 2404-1a and the statistics table 2404-1b store the same information, and the statistics table 2404-2a and the statistics table 2404-2b store the same information, for example.

The statistics notifying processing S2650, which is executed by the statistics adding-up module 2401, is described below.

<Statistics Notifying Processing S2650>

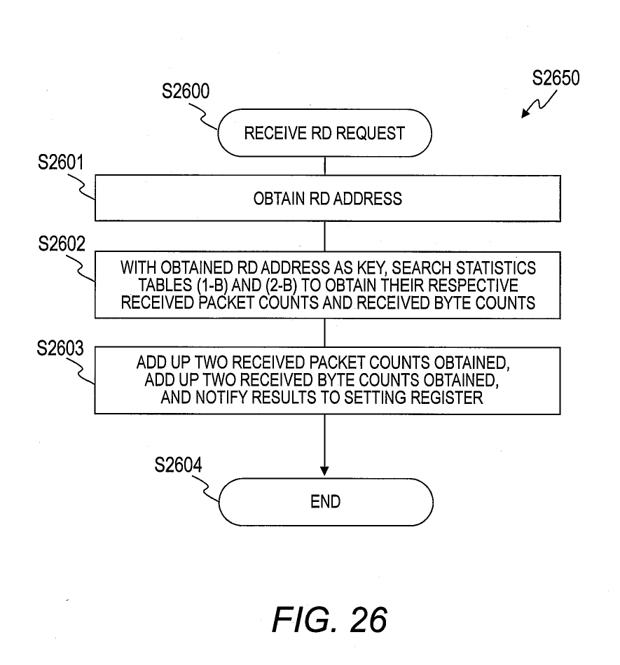

FIG. 26 is a flow chart illustrating the statistics notifying processing S2650, which is executed by the statistics adding-up module 2401 of the third embodiment. The statistics adding-up module 2401 receives an RD request from the setting register 2407 (S2600), and obtains an RD address that is received at the same time as the RD request from the setting register 2407 (S2601).

After Step S2601, the statistics adding-up module 2401 uses a flow ID that is associated with the RD address obtained in Step S2601 as a key to search the statistics table 2404-1b and the statistics table 2404-2b, and obtains a received packet count and a received byte count that are associated with the flow ID from each of the statistics tables 2404-1b and 2404-2b (S2602). After Step S2602, the statistics adding-up module 2401 adds up the two received packet counts obtained in Step S2602, and similarly adds up the obtained two received byte counts, to notify the counts to the setting register 2407 (S2603). After Step S2603, the statistics adding-up module 2401 ends the statistics notifying processing S2650 illustrated in FIG. 26 (S2604).

As described above, the communication apparatus 3 according to the third embodiment configures a virtual multi-port table from a plurality of 1RD/1WR statistics tables 2404 (2404-1a, 2404-1b, 2404-2a, and 2404-2b) in the input table updating unit 2409. The communication apparatus 3 of the third embodiment can thus execute table updating processing even when two packets arrive every clk and an RD of statistics information by the CPU is additionally executed.

While the third embodiment discusses the case where two packets arrive every clk and an RD of statistics information by the CPU is additionally executed, the communication apparatus 3 is also capable of executing table updating processing when, for example, K (K is an arbitrary natural number) packets arrive every clk and an RD of statistics information by the CPU is additionally executed, by providing K statistics table sets 2405 and configuring the statistics table sets 2405 in the input table updating unit 2409 and adding up pieces of information that are obtained from K statistics tables by the statistics adding-up module 2401.

Therefore, according to the third embodiment, table updating processing of a computation function of the type of statistics counting function is accomplished in high-speed packet processing that deals with the arrival of a plurality of packets in one clk, by configuring one virtual table and concurrently executing a plurality of RDs and a plurality of WRs in one clk, even when a single table is capable of processing only one RD and one WR in one clk.

A virtual multi-port table is applied to a computation function of the type of band control function in the communication apparatus of the first embodiment and the second embodiment. The communication apparatus of the third embodiment applies a virtual multi-port table to a computation function of the type of statistics counting function. Alternatively, a virtual multi-port table may be applied to those two functions that are included in one communication apparatus. For instance, in the case where two packets arrive every clk, the first embodiment and the third embodiment may be combined so that the communication apparatus 3 includes the input packet control unit 303 and the input table updating unit 309 for the band control function, and the input packet control unit 303 and the input table updating unit 2409 for the statistics counting function.

The communication apparatus 3 may instead include one common input packet control unit 303, the input table updating unit 309 for the band control function, and the input table updating unit 2409 for the statistics counting function by using the packet processing modules 402 to execute processing of the band control function and processing of the statistics counting function.

The statistics counting function in the third embodiment, which is an embodiment of this invention in terms of a computation function of the statistics counting function, may be implemented with the use of the table updating processing described in the first embodiment and the second embodiment. For instance, in the case where two packets arrive in one clk, the communication apparatus 3 may configure each of the two computation table sets 505 (505-1 and 505-2) of the first embodiment from three computation tables 504, and access the computation tables 504 of the respective computation table sets 505 to process an RD of statistics information by the CPU and to process two RDs due to packet arrival (three RDs in total) in a manner that avoids contention.

As described above, according to the embodiments of this invention, table updating processing of the band control function and the statistics counting function is accomplished in high-speed packet processing that deals with the arrival of a plurality of packets in one clk, by configuring a virtual multi-port table to concurrently execute a plurality of RDs and a plurality of WRs in one clk, even when a single table is capable of processing only one RD and one WR in one clk.

It should be noted that this invention is not limited to the above-mentioned embodiments, and encompasses various modification examples and the equivalent configurations within the scope of the appended claims without departing from the gist of this invention. For example, the above-mentioned embodiments are described in detail for a better understanding of this invention, and this invention is not necessarily limited to what includes all the configurations that have been described. Further, a part of the configurations according to a given embodiment may be replaced by the configurations according to another embodiment. Further, the configurations according to another embodiment may be added to the configurations according to a given embodiment. Further, a part of the configurations according to each embodiment may be added to, deleted from, or replaced by another configuration.

Further, a part or entirety of the respective configurations, functions, processing modules, processing means, and the like that have been described may be implemented by hardware, for example, may be designed as an integrated circuit, or may be implemented by software by a processor interpreting and executing programs for implementing the respective functions.

The information on the programs, tables, files, and the like for implementing the respective functions can be stored in a storage device such as a memory, a hard disk drive, or a solid state drive (SSD) or a recording medium such as an IC card, an SD card, or a DVD.

Further, control lines and information lines that are assumed to be necessary for the sake of description are described, but not all the control lines and information lines that are necessary in terms of implementation are described. It may be considered that almost all the components are connected to one another in actuality.

This invention includes other aspects than those described in Scope of Claims, and exemplary aspects thereof are given below.

(Supplementary Note 1) A communication apparatus to be coupled to a network, including:

a table set group including a plurality of table sets each containing a plurality of tables capable of processing one read request and one write request from the network in the same clock cycle, and holding flow-by-flow information in a synchronized manner;

an updating unit for processing each of a plurality of read requests received simultaneously from the network by accessing one of the plurality of tables in one of the plurality of table sets that is associated with the each of the plurality read requests and executing read processing in the one of the plurality of tables, and, when a plurality of write requests are received at the same time as the plurality of read requests, processes each of the plurality of write requests by accessing all tables in one of the plurality of table sets that is associated with the each of the plurality of write requests, and executing write processing in the all tables; and

an executing module for executing, when a read request related to particular processing is received at the same time as the plurality of read requests, read processing in a particular table in each of the plurality of table sets which is not the one of the plurality of tables.

(Supplementary Note 2) The communication apparatus according to Supplementary Note 1,

in which computation results related to packets which are received from the network are written in response to the plurality of write requests in the respective tables of the plurality of table sets, and

in which the executing module is a statistics adding-up module for adding up the computation results that are read out of the respective particular tables.

What is claimed is:

1. A communication apparatus to be coupled to a network, comprising:
a table set group comprising a plurality of table sets each containing a plurality of tables capable of processing one read request and one write request from the network at the same timing, and holding flow-by-flow information in a synchronized manner;
a latest access holding table for specifying, for each flow, one of the plurality of table sets that is a latest access destination of the each flow; and
an updating unit for selecting, when a reference made to the latest access holding table with respect to a plurality of write requests received simultaneously from the network shows that access destinations of flows indicated by the respective write requests are the same table set, as an access destination, a different table set out of the plurality of table sets for each of the flows indicated by the respective write requests, executing write processing in each table in one of the plurality of table sets that is the selected access destination, and updating the latest access holding table so that the access destinations after the write processing are registered as access destinations of the flows indicated by the respective write requests.

2. The communication apparatus according to claim 1, wherein, when a reference made to the latest access holding table with respect to the plurality of write requests shows that access destinations of flows indicated by the respective write requests are different table sets, the updating unit selects the different table sets as access destinations respectively for the flows indicated by the respective write requests, and executes, in each of the table sets that are the selected access destinations, write processing in each table of the each of the table sets.

3. The communication apparatus according to claim 1, wherein, when a reference made to the latest access holding table with respect to a plurality of read requests that are received at the same time as the plurality of write requests shows that access destinations of flows indicated by the respective read requests are the same table set, the updating unit selects as an access destination a different table within the same table set for each of the flows indicated by the respective read requests, and executes read processing in each table that is the selected access destination.

4. The communication apparatus according to claim 1, wherein, when a reference made to the latest access holding table with respect to a plurality of read requests that are received at the same time as the plurality of write requests shows that access destinations of flows indicated by the respective read requests are different table sets, the updating unit executes, for each of the flows indicated by the respective read requests, read processing in one of the plurality of tables within the table set that is the access destination of the each of the flows.

5. The communication apparatus according to claim 1, further comprising a management table for storing, for each flow, information that defines whether or not write processing is being executed in association with information that specifies one of the plurality of table sets where the write processing is being executed,
wherein the updating unit refers to the management table and, when a write destination of a flow indicated by one of the plurality of write requests which is specified by the latest access holding table is identified as one of the plurality of table sets where the write processing is being executed through the reference to the management table, changes the write destination of the flow to the one of the plurality of table sets where the write processing is being executed.

6. A communication method to be carried out by a communication apparatus to be coupled to a network,
the communication apparatus comprising:
a table set group comprising a plurality of table sets each containing a plurality of tables capable of processing one read request and one write request from the network at the same timing, and holding flow-by-flow information in a synchronized manner;
a latest access holding table for specifying, for each flow, one of the plurality of table sets that is a latest access destination of the each flow; and
an updating unit for updating the table set group and the latest access holding table,
the communication method comprising executing, by the updating unit:
processing of selecting, when a reference made to the latest access holding table with respect to a plurality of write requests received simultaneously shows that access destinations of flows indicated by the respective write requests are the same table set, as an access destination, a different table set out of the plurality of table sets for each of the flows indicated by the respective write requests, and executing write processing in each table in one of the plurality of table sets that is the selected access destination; and
processing of updating the latest access holding table so that the access destinations after the write processing are registered as access destinations of the flows indicated by the respective write requests.

7. The communication method according to claim 6, further comprising selecting, by the updating unit, when a reference made to the latest access holding table with respect to the plurality of write requests shows that access destinations of flows indicated by the respective write requests are different table sets, the different table sets as access destinations respectively for the flows indicated by the respective write requests, and executing, in each of the table sets that are the selected access destinations, write processing in each table of the each of the table sets.

8. The communication method according to claim 6, further comprising selecting, by the updating unit, when a reference made to the latest access holding table with respect to a plurality of read requests that are received at the same time as the plurality of write requests shows that access destinations of flows indicated by the respective read requests are the same table set, as an access destination a different table within the same table set for each of the flows indicated by the respective read requests, and executing read processing in each table that is the selected access destination.

9. The communication method according to claim 6, further comprising executing, by the updating unit, when a reference made to the latest access holding table with respect to a plurality of read requests that are received at the same time as the plurality of write requests shows that access destinations of flows indicated by the respective read requests are different table sets, for each of the flows indicated by the respective read requests, read processing in one of the plurality of tables within the table set that is the access destination of the each of the flows.

10. The communication method according to claim 6,
wherein the communication apparatus further comprises a management table for storing, for each flow, information that defines whether or not write processing is being executed in association with information that specifies one of the plurality of table sets where the write processing is being executed, and
wherein the communication method further comprises referring, by the updating unit, to the management table and, when a write destination of a flow indicated by one of the plurality of write requests which is specified by the latest access holding table is identified as one of the plurality of table sets where the write processing is being executed through the reference to the management table, changing the write destination of the flow to the one of the plurality of table sets where the write processing is being executed.

11. A non-transitory processor-readable recording medium having stored thereon a program to be executed by a processor of a communication apparatus to be coupled to a network, the non-transitory recording medium being readable by the processor,
the communication apparatus comprising:
a table set group comprising a plurality of table sets each containing a plurality of tables capable of processing one read request and one write request from the network at the same timing, and holding flow-by-flow information in a synchronized manner; and
a latest access holding table for specifying, for each flow, one of the plurality of table sets that is a latest access destination of the each flow,
the program causing the processor to execute:
processing of selecting, when a reference made to the latest access holding table with respect to a plurality of write requests received simultaneously from the network shows that access destinations of flows indicated by the respective write requests are the same table set, as an access destination, a different table set out of the plurality of table sets for each of the flows indicated by the respective write requests, and executing write processing in each table in one of the plurality of table sets that is the selected access destination; and
processing of updating the latest access holding table so that the access destinations after the write processing are registered as access destinations of the flows indicated by the respective write requests.

12. The non-transitory processor-readable recording medium according to claim 11, wherein the program further causes the processor to select, when a reference made to the latest access holding table with respect to the plurality of write requests shows that access destinations of flows indicated by the respective write requests are different table sets, the different table sets as access destinations respectively for the flows indicated by the respective write requests, and execute, in each of the table sets that are the selected access destinations, write processing in each table of the each of the table sets.

13. The non-transitory processor-readable recording medium according to claim 11, wherein the program further causes the processor to select, when a reference made to the latest access holding table with respect to a plurality of read requests that are received at the same time as the plurality of write requests shows that access destinations of flows indicated by the respective read requests are the same table set, as an access destination, a different table within the same table set for each of the flows indicated by the respective read requests, and execute read processing in each table that is the selected access destination.

14. The non-transitory processor-readable recording medium according to claim 11, wherein the program-further causes the processor to execute, when a reference made to the latest access holding table with respect to a plurality of read requests that are received at the same time as the plurality of write requests shows that access destinations of flows indicated by the respective read requests are different table sets, for each of the flows indicated by the respective read requests, read processing in one of the plurality of tables within the table set that is the access destination of the each of the flows.

15. The non-transitory processor-readable recording medium according to claim 11,
wherein the communication apparatus further comprises a management table for storing, for each flow, information that defines whether or not write processing is being executed in association with information that specifies one of the plurality of table sets where the write processing is being executed, and
wherein the program further causes the processor to refer to the management table and, when a write destination of a flow indicated by one of the plurality of write requests which is specified by the latest access holding table is identified as one of the plurality of table sets where the write processing is being executed through the reference to the management table, change the write destination of the flow to the one of the plurality of table sets where the write processing is being executed.
